(19) United States
(12) Patent Application Publication
(10) Pub. No.: US 2019/0034734 A1
(43) Pub. Date: Jan. 31, 2019

(54) OBJECT CLASSIFICATION USING MACHINE LEARNING AND OBJECT TRACKING

(71) Applicant: QUALCOMM Incorporated, San Diego, CA (US)

(72) Inventors: Chen-Lan Chester YEN, Carlsbad, CA (US); Ying CHEN, San Diego, CA (US); Chinchuan CHIU, Poway, CA (US)

(21) Appl. No.: 16/037,912

(22) Filed: Jul. 17, 2018

Related U.S. Application Data
(60) Provisional application No. 62/538,566, filed on Jul. 28, 2017.

(51) Int. Cl. G06K 9/00; G06K 9/32; G06T 7/11; G06K 9/20; G06N 5/04; G06N 3/08; G06T 3/40

(52) U.S. Cl. CPC G06K 9/00718; G06K 9/3233; G06T 7/11; G06T 3/4084; G06N 5/046; G06N 3/084; G06K 9/2054

(57) ABSTRACT

Techniques and systems are provided for classifying objects in one or more video frames. For example, one or more bounding regions are determined for a current video frame of a scene. The one or bounding regions are determined based on object tracking performed for one or more blobs detected for the current video frame. The one or more bounding regions are associated with the one or more blobs. A blob includes pixels of at least a portion of one or more objects in the current video frame. One or more regions of interest are determined in the current video frame of the scene. The one or more regions of interest are determined using the one or more bounding regions determined for the current video frame. One or more objects within the one or more regions of interest are classified using a trained network applied to the one or more regions of interest.

### CROSS-REFERENCE TO RELATED APPLICATIONS

This application claims the benefit of U.S. Provisional Application No. 62/538,566, filed Jul. 28, 2017, which is hereby incorporated by reference, in its entirety and for all purposes.

### FIELD

The present disclosure generally relates to video analytics and object classification, and more specifically to techniques and systems for classifying objects in images by performing object tracking and machine learning techniques.

### BACKGROUND

Many devices and systems allow a scene to be captured by generating video data of the scene. For example, an Internet protocol camera (IP camera) is a type of digital video camera that can be employed for surveillance or other applications. Unlike analog closed circuit television (CCTV) cameras, an IP camera can send and receive data via a computer network and the Internet. The video data from these devices and systems can be captured and output for processing and/or consumption.

Video analytics, also referred to as Video Content Analysis (VCA), is a generic term used to describe computerized processing and analysis of a video sequence acquired by a camera. Video analytics provides a variety of tasks, including immediate detection of events of interest, analysis of pre-recorded video for the purpose of extracting events in a long period of time, and many other tasks. For instance, using video analytics, a system can automatically analyze the video sequences from one or more cameras to detect one or more events. In some cases, video analytics can send alerts or alarms for certain events of interest. More advanced video analytics is needed to provide efficient and robust video sequence processing.

### BRIEF SUMMARY

In some examples, techniques and systems are described for classifying objects in images by performing object tracking and machine learning (e.g., using a deep neural network). For example, results from an object tracking system can be used by a machine learning system to perform object classification and localization. Object tracking can be performed using a video analytics system that performs object detection and object tracking. For example, a blob detection component of a video analytics system can use data from one or more video frames to generate or identify blobs for the one or more video frames. A blob represents at least a portion of one or more objects in a video frame (also referred to as a “picture”). Blob detection can utilize background subtraction to determine a background portion of a scene and a foreground portion of scene. Blobs can then be detected based on the foreground portion of the scene.

The detected blobs can be provided, for example, for blob processing, object tracking, and other video analytics functions. For instance, temporal information of the blobs can be used to identify stable objects or blobs so that a tracking layer can be established. Object tracking can be performed to track the detected blobs and the objects represented by the blobs. Bounding regions (e.g., bounding boxes or bounding regions having other suitable shapes) can be maintained by the video analytics system and can be associated with trackers and tracked blobs. For example, a bounding region can be displayed as tracking a tracked blob when certain conditions are met (e.g., the blob has been tracked for a certain number of frames, a certain period of time, and/or other suitable conditions).

Machine learning networks can be used for many purposes, including classifying (or identifying) and/or localizing objects in an image. In one example, a system using a deep learning network can be used to identify objects in an image based on past information about similar objects that the network has learned based on training data. In one illustrative example, training data can include images of objects used to train the network. Many examples of deep learning networks are available, including convolutional neural networks (CNNs), autoencoders, deep belief nets (DBNs), Recurrent Neural Networks (RNNs), among others.

Machine learning networks can include trained neural networks (also referred to as trained networks). A deep learning network (also referred to as deep networks and deep neural networks) is one example of a trained neural network. A deep learning network can include an input layer, multiple hidden layers, and an output layer with several nodes. In some cases, a trained neural network can include a single hidden layer. Nodes can include neurons, filters, kernels, or other suitable nodes that can provide data, functions, or the like. The nodes can include weights used to indicate an importance of the nodes of one or more of the layers. In some cases, a deep learning network can have a series of many hidden layers, with early layers determining simple and low level characteristics of an input, and later layers building up a hierarchy of more complex and abstract characteristics. In a classification network, a deep learning network can classify an object using high-level features determined by the later layers of the neural network. In some cases, the output from the output layer can be a single class or can include a probability of classes that best describe the object. For example, the output can include probability values indicating probabilities that the object includes different classes of objects (e.g., a probability the object is a person, a probability the object is a dog, a probability the object is a cat, or the like).

Deep learning networks can be problematic when used to classify and/or localize objects in a video sequence. For example, deep learning can perform poorly when an object is small relative to the height of the video frame, making it difficult to obtain an all-range classification for objects in the near and far ranges (or depths) of the image frame. Further, a large number of hidden layers are required for a deep learning network to classify an object in an image or frame (with even more complex networks being needed for small objects), leading to slow processing times that are insufficient for classifying objects in a video sequence in real-time. As used herein, the term “real-time” refers to classifying objects in a video sequence as the video sequence is being captured.

Object detection and tracking performed by a video analytics system also encounter problems when attempting to detect and track objects in a video sequence. For example, multiple objects can be detected and tracked as a single object when the objects are merged together into a single blob. In another example, object tracking can encounter issues tracking objects that are split from a previously merged object (e.g., when two people split apart after being close to one another for a period of time). In yet another example, a single object can be incorrectly detected and tracked as multiple objects when the object is detected as two or more blobs (referred to as a split). Other issues may arise with respect to false positives. For example, moving background objects (e.g., objects moving due to wind or other external force, shadows, or the like) may be detected and tracked as false positives by the video analytics system.

Object classification techniques and systems are described herein that can perform all-range object classification and localization in real-time, while providing the benefits of both video analytics-based object tracking and deep learning networks. To obtain all-range object classification in real-time, a video analytics system can perform object detection to detect one or more blobs (representing one or more objects) for a video frame and can perform object tracking to associate trackers (bounding boxes or other type of bounding regions) with the one or more blobs. The bounding boxes assigned to the one or more blobs by object tracking can be periodically output to a deep learning system, which can determine one or more regions of interest (ROIs) from the bounding boxes. The deep learning system can crop the part of the original video frame corresponding to the one or more ROIs such that the one or more ROIs are cropped from the original frame. The deep learning system can then apply a trained neural network (e.g., a deep learning network, such as a CNN, an autoencoder, a DBN, an RNN, or another suitable trained network) to the cropped portion of the video frame instead of the entire video frame to classify and localize (determine the location of) the one or more objects in the ROIs. In some cases, object detection and tracking can be performed for every frame of a video sequence, while the classification process (using the deep learning system) can be performed periodically for less than all of the video frames of the video sequence. The classification process can be applied to less than all of the video frames due to the classification process requiring multiple video frames to classify and localize objects in the ROIs. In some cases, for a given image of a scene, a video frame used by object detection and tracking can be of a lower resolution than a video frame used by the deep learning system, in which case the two video frames will include the same image of the scene, but at different resolutions.

According to at least one example, a method of classifying objects in one or more video frames provided. The method includes determining one or more bounding regions for a current video frame of a scene. The one or bounding regions are determined based on object tracking performed for one or more blobs detected for the current video frame. The one or more bounding regions are associated with the one or more blobs. A blob includes pixels of at least a portion of one or more objects in the current video frame. The method further includes determining one or more regions of interest in the current video frame of the scene. The one or more regions of interest are determined using the one or more bounding regions determined for the current video frame. The method further includes classifying one or more objects within the one or more regions of interest. The one or more objects are classified using a first trained network applied to the one or more regions of interest.

In another example, an apparatus for classifying objects in one or more video frames is provided that includes a memory configured to store video data and a processor. The processor is configured to and can determine one or more bounding regions for a current video frame of a scene. The one or bounding regions are determined based on object tracking performed for one or more blobs detected for the current video frame. The one or more bounding regions are associated with the one or more blobs. A blob includes pixels of at least a portion of one or more objects in the current video frame. The processor is further configured to and can determine one or more regions of interest in the current video frame of the scene. The one or more regions of interest are determined using the one or more bounding regions determined for the current video frame. The processor is further configured to and can classify one or more objects within the one or more regions of interest. The one or more objects are classified using a first trained network applied to the one or more regions of interest.

In another example, a non-transitory computer-readable medium is provided that has stored thereon instructions that, when executed by one or more processors, cause the one or more processor to: determine one or more bounding regions for a current video frame of a scene, the one or bounding regions being determined based on object tracking performed for one or more blobs detected for the current video frame, wherein the one or more bounding regions are associated with the one or more blobs, and wherein a blob includes pixels of at least a portion of one or more objects in the current video frame; determine one or more regions of interest in the current video frame of the scene, wherein the one or more regions of interest are determined using the one or more bounding regions determined for the current video frame; and classify one or more objects within the one or more regions of interest, wherein the one or more objects are classified using a first trained network applied to the one or more regions of interest.

In another example, an apparatus for classifying objects in one or more video frames is provided. The apparatus includes means for determining one or more bounding regions for a current video frame of a scene. The one or bounding regions are determined based on object tracking performed for one or more blobs detected for the current video frame. The one or more bounding regions are associated with the one or more blobs. A blob includes pixels of at least a portion of one or more objects in the current video frame. The apparatus further includes means for determining one or more regions of interest in the current video frame of the scene. The one or more regions of interest are determined using the one or more bounding regions determined for the current video frame. The apparatus further includes means for classifying one or more objects within the one or more regions of interest. The one or more objects are classified using a first trained network applied to the one or more regions of interest.

In some aspects, the first trained network is not applied to regions of the current video frame that are outside of the one or more regions of interest.

In some aspects, the one or more regions of interest encompass the one or more bounding regions determined for the first video frame.

In some aspects, the one or more objects within the one or more regions of interest are classified in real-time using the first trained network as a video sequence comprising the current video frame is received.

In some aspects, the methods, apparatuses, and computer-readable medium described above further comprise updating a status of the one or more objects, the status indicating the one or more blobs representing the one or more objects have been classified.

In some aspects, the object tracking is performed on a first version of the current video frame to determine the one or more bounding regions, and the first trained network is applied to a cropped portion of a second version of the current video frame. The cropped portion of the second version of the current video frame corresponds to the one or more regions of interest.

In some aspects, the first version of the current video frame has a first resolution and the second version of the current video frame has a second resolution, in which case the first resolution is a lower resolution than the second resolution. In some aspects, the first version of the current video frame is a downsampled version of the second version of the current video frame. In some aspects, the first version of the current video frame and the second version of the current video frame include different video frames having different resolutions, and wherein the first version of the current video frame and the second version of the current video frame capture the scene at a same time instance.

In some aspects, object tracking results from one or more video frames of a video sequence are periodically used by the first trained network to classify one or more objects in the one or more video frames.

In some aspects, the methods, apparatuses, and computer-readable medium described above further comprise: determining an object was not classified by a previous iteration of the first trained network in a previous video frame; determining, based on the object not being classified by the previous iteration of the first trained network, a region of interest containing the object in the current video frame, the region of interest being determined using a bounding region associated with a blob representing the object; and applying the first trained network to the region of interest in the current video frame. In some aspects, the current video frame is a first video frame after completion of the previous iteration of the first trained network.

In some aspects, the methods, apparatuses, and computer-readable medium described above further comprise: determining an object was classified by a previous iteration of the first trained network in a previous video frame; and determining not to apply the first trained network on the object based on the object being classified by the previous iteration of the first trained network.

In some aspects, the methods, apparatuses, and computer-readable medium described above further comprise: determining a classification confidence score determined for an object using a previous iteration of the first trained network in a previous video frame; determining the classification confidence score for the object is below a threshold score; determining, based on the classification confidence score being below the threshold score, a region of interest containing the object in the current video frame, the region of interest being determined using a bounding region determined for a blob representing the object; and applying the first trained network to the region of interest in the current video frame. In some aspects, the current video frame is a first video frame after completion of the previous iteration of the first trained network.

In some aspects, the methods, apparatuses, and computer-readable medium described above further comprise: determining a blob detected in one or more previous video frames is no longer detected in the current frame, the blob being associated with an object in the scene; determining the object was not classified by the first trained network in the one or more previous video frames; identifying a region of interest of a previous video frame containing the object; and classifying the object contained within the region of interest, wherein the object is classified using a second trained network applied to the region of interest, the second trained network having more hidden layers than the first trained network. In some aspects, the first trained network is performed for the object until the blob associated with the object is no longer detected. In some aspects, the region of interest includes a queued region of interest, wherein the region of interest is selected to be the queued region of interest from among regions of interest determined for the one or more previous frames. In some aspects, the region of interest is selected to be the queued region of interest from among the regions of interest determined for the one or more previous frames based on one or more factors associated with the region of interest. In some aspects, the one or more factors associated with the region of interest include at least one of a sharpness of the object in the region of interest or a size of the object in the region of interest.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following drawing figures:

FIG. 1 is a block diagram illustrating an example of a system including a video source and a video analytics system, in accordance with some examples.

FIG. 2 is an example of a video analytics system processing video frames, in accordance with some examples.

FIG. 3 is a block diagram illustrating an example of a blob detection system, in accordance with some examples.

FIG. 4 is a block diagram illustrating an example of an object tracking system, in accordance with some examples.

FIG. 5 is a chart illustrating object size versus true positive rate for a deep learning network, in accordance with some examples.

FIG. 6 is a block diagram illustrating an example of a video analytics system including a deep learning system, in accordance with some examples.

FIG. 7 is a diagram illustrating an example of a deep learning system, in accordance with some examples.

FIG. 8 is a diagram illustrating an example data flow for an object classification process using object tracking and deep learning, in accordance with some examples.

FIG. 9 is a diagram illustrating another example data flow for an object classification process using object tracking and deep learning, in accordance with some examples.

FIG. 10 is a diagram illustrating an example data flow for a detached forensic deep learning network process, in accordance with some examples.

FIG. 11 is a block diagram illustrating an example of a deep learning network, in accordance with some examples.

FIG. 12 is a block diagram illustrating an example of a convolutional neural network, in accordance with some examples.

FIG. 13 is a diagram illustrating an example of real-time event hit-rate enhancement, in accordance with some examples.

FIG. 14 is a flowchart illustrating an example of an object classification process, in accordance with some embodiments.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

A video analytics system can obtain a sequence of video frames from a video source and can process the video sequence to perform a variety of tasks. One example of a video source can include an Internet protocol camera (IP camera) or other type of video capture device. An IP camera is a type of digital video camera that can be used for surveillance, home security, or other suitable application. Unlike analog closed circuit television (CCTV) cameras, an IP camera can send and receive data via a computer network and the Internet. In some instances, one or more IP cameras can be located in a scene or an environment, and can remain static while capturing video sequences of the scene or environment.

An IP camera can be used to send and receive data via a computer network and the Internet. In some cases, IP camera systems can be used for two-way communications. For example, data (e.g., audio, video, metadata, or the like) can be transmitted by an IP camera using one or more network cables or using a wireless network, allowing users to communicate with what they are seeing. In one illustrative example, a gas station clerk can assist a customer with how to use a pay pump using video data provided from an IP camera (e.g., by viewing the customer's actions at the pay pump). Commands can also be transmitted for pan, tilt, zoom (PTZ) cameras via a single network or multiple networks. Furthermore, IP camera systems provide flexibility and wireless capabilities. For example, IP cameras provide for easy connection to a network, adjustable camera location, and remote accessibility to the service over Internet. IP camera systems also provide for distributed intelligence. For example, with IP cameras, video analytics can be placed in the camera itself. Encryption and authentication is also easily provided with IP cameras. For instance, IP cameras offer secure data transmission through already defined encryption and authentication methods for IP based applications. Even further, labor cost efficiency is increased with IP cameras. For example, video analytics can produce alarms for certain events, which reduces the labor cost in monitoring all cameras (based on the alarms) in a system.

Video analytics provides a variety of tasks ranging from immediate detection of events of interest, to analysis of pre-recorded video for the purpose of extracting events in a long period of time, as well as many other tasks. Various research studies and real-life experiences indicate that in a surveillance system, for example, a human operator typically cannot remain alert and attentive for more than 20 minutes, even when monitoring the pictures from one camera. When there are two or more cameras to monitor or as time goes beyond a certain period of time (e.g., 20 minutes), the operator's ability to monitor the video and effectively respond to events is significantly compromised. Video analytics can automatically analyze the video sequences from the cameras and send alarms for events of interest. This way, the human operator can monitor one or more scenes in a passive mode. Furthermore, video analytics can analyze a huge volume of recorded video and can extract specific video segments containing an event of interest.

Video analytics also provides various other features. For example, video analytics can operate as an Intelligent Video Motion Detector by detecting moving objects and by tracking moving objects. In some cases, the video analytics can generate and display a bounding region (e.g., a bounding box) around a valid object. Video analytics can also act as an intrusion detector, a video counter (e.g., by counting people, objects, vehicles, or the like), a camera tamper detector, an object left detector, an object/asset removal detector, an asset protector, a loitering detector, and/or as a slip and fall detector. Video analytics can further be used to perform various types of recognition functions, such as face detection and recognition, license plate recognition, object recognition (e.g., bags, logos, body marks, or the like), or other recognition functions. In some cases, video analytics can be trained to recognize certain objects. Another function that can be performed by video analytics includes providing demographics for customer metrics (e.g., customer counts, gender, age, amount of time spent, and other suitable metrics). Video analytics can also perform video search (e.g., extracting basic activity for a given region) and video summary (e.g., extraction of the key movements). In some instances, event detection can be performed by video analytics, including detection of fire, smoke, fighting, crowd formation, or any other suitable even the video analytics is programmed to or learns to detect. A detector can trigger the detection of an event of interest and can send an alert or alarm to a central control room to alert a user of the event of interest.

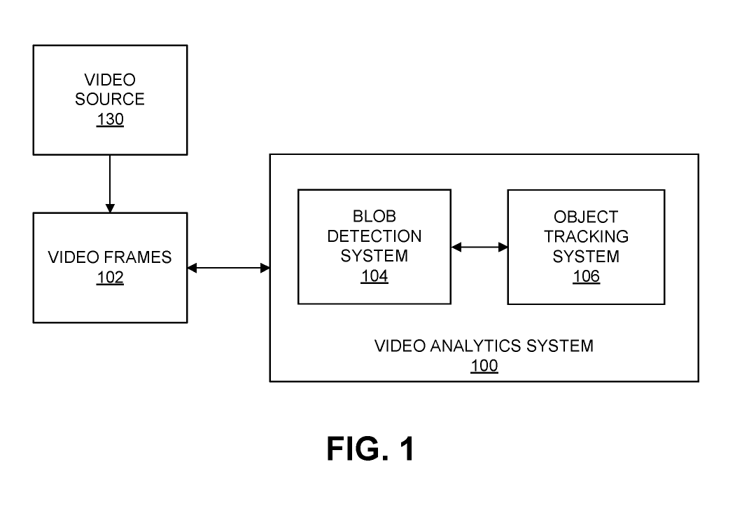

As described in more detail herein, a video analytics system can generate and detect foreground blobs that can be used to perform various operations, such as object tracking (also called blob tracking) and/or some of the other operations described above. A blob tracker (also referred to as an object tracker) can be used to track one or more blobs in a video sequence using one or more bounding regions. Details of an example video analytics system are described below with respect to FIG. 1-FIG. 4.

FIG. 1 is a block diagram illustrating an example of a video analytics system 100. The video analytics system 100 receives video frames 102 from a video source 130. The video frames 102 can also be referred to herein as a video picture or a picture. The video frames 102 can be part of one or more video sequences. The video source 130 can include a video capture device (e.g., a video camera, a camera phone, a video phone, or other suitable capture device), a video storage device, a video archive containing stored video, a video server or content provider providing video data, a video feed interface receiving video from a video server or content provider, a computer graphics system for generating computer graphics video data, a combination of such sources, or other source of video content. In one example, the video source 130 can include an IP camera or multiple IP cameras. In an illustrative example, multiple IP cameras can be located throughout an environment, and can provide the video frames 102 to the video analytics system 100. For instance, the IP cameras can be placed at various fields of view within the environment so that surveillance can be performed based on the captured video frames 102 of the environment.

In some embodiments, the video analytics system 100 and the video source 130 can be part of the same computing device. In some embodiments, the video analytics system 100 and the video source 130 can be part of separate computing devices. In some examples, the computing device (or devices) can include one or more wireless transceivers for wireless communications. The computing device (or devices) can include an electronic device, such as a camera (e.g., an IP camera or other video camera, a camera phone, a video phone, or other suitable capture device), a mobile or stationary telephone handset (e.g., smartphone, cellular telephone, or the like), a desktop computer, a laptop or notebook computer, a tablet computer, a set-top box, a television, a display device, a digital media player, a video gaming console, a video streaming device, or any other suitable electronic device.

The video analytics system 100 includes a blob detection system 104 and an object tracking system 106. Object detection and tracking allows the video analytics system 100 to provide various end-to-end features, such as the video analytics features described above. For example, intelligent motion detection, intrusion detection, and other features can directly use the results from object detection and tracking to generate end-to-end events. Other features, such as people, vehicle, or other object counting and classification can be greatly simplified based on the results of object detection and tracking. The blob detection system 104 can detect one or more blobs in video frames (e.g., video frames 102) of a video sequence, and the object tracking system 106 can track the one or more blobs across the frames of the video sequence. As used herein, a blob refers to foreground pixels of at least a portion of an object (e.g., a portion of an object or an entire object) in a video frame. For example, a blob can include a contiguous group of pixels making up at least a portion of a foreground object in a video frame. In another example, a blob can refer to a contiguous group of pixels making up at least a portion of a background object in a frame of image data. A blob can also be referred to as an object, a portion of an object, a blotch of pixels, a pixel patch, a cluster of pixels, a blot of pixels, a spot of pixels, a mass of pixels, or any other term referring to a group of pixels of an object or portion thereof. In some examples, a bounding region can be associated with a blob. In some examples, a tracker can also be represented by a tracker bounding region. A bounding region of a blob or tracker can include a bounding box, a bounding circle, a bounding ellipse, or any other suitably-shaped region representing a tracker and/or a blob. While examples are described herein using bounding boxes for illustrative purposes, the techniques and systems described herein can also apply using other suitably shaped bounding regions. A bounding box associated with a tracker and/or a blob can have a rectangular shape, a square shape, or other suitable shape. In the tracking layer, in case there is no need to know how the blob is formulated within a bounding box, the term blob and bounding box may be used interchangeably.

As described in more detail below, blobs can be tracked using blob trackers. A blob tracker can be associated with a tracker bounding box and can be assigned a tracker identifier (ID). In some examples, a bounding box for a blob tracker in a current frame can be the bounding box of a previous blob in a previous frame for which the blob tracker was associated. For instance, when the blob tracker is updated in the previous frame (after being associated with the previous blob in the previous frame), updated information for the blob tracker can include the tracking information for the previous frame and also prediction of a location of the blob tracker in the next frame (which is the current frame in this example). The prediction of the location of the blob tracker in the current frame can be based on the location of the blob in the previous frame. A history or motion model can be maintained for a blob tracker, including a history of various states, a history of the velocity, and a history of location, of continuous frames, for the blob tracker, as described in more detail below.

In some examples, a motion model for a blob tracker can determine and maintain two locations of the blob tracker for each frame. For example, a first location for a blob tracker for a current frame can include a predicted location in the current frame. The first location is referred to herein as the predicted location. The predicted location of the blob tracker in the current frame includes a location in a previous frame of a blob with which the blob tracker was associated. Hence, the location of the blob associated with the blob tracker in the previous frame can be used as the predicted location of the blob tracker in the current frame. A second location for the blob tracker for the current frame can include a location in the current frame of a blob with which the tracker is associated in the current frame. The second location is referred to herein as the actual location. Accordingly, the location in the current frame of a blob associated with the blob tracker is used as the actual location of the blob tracker in the current frame. The actual location of the blob tracker in the current frame can be used as the predicted location of the blob tracker in a next frame. The location of the blobs can include the locations of the bounding boxes of the blobs.

The velocity of a blob tracker can include the displacement of a blob tracker between consecutive frames. For example, the displacement can be determined between the centers (or centroids) of two bounding boxes for the blob tracker in two consecutive frames. In one illustrative example, the velocity of a blob tracker can be defined as Vₜ=Cₜ−Cₜ₋₁, where Cₜ−Cₜ₋₁=(Cₜₓ−Cₜ₋₁ₓ, C_{ty}−C_{t-1y}). The term Cₜ(Cₜₓ, C_{ty}) denotes the center position of a bounding box of the tracker in a current frame, with Cₜₓ being the x-coordinate of the bounding box, and C_{ty} being the y-coordinate of the bounding box. The term Cₜ₋₁(Cₜ₋₁ₓ, C_{t-1y}) denotes the center position (x and y) of a bounding box of the tracker in a previous frame. In some implementations, it is also possible to use four parameters to estimate x, y, width, height at the same time. In some cases, because the timing for video frame data is constant or at least not dramatically different overtime (according to the frame rate, such as 30 frames per second, 60 frames per second, 120 frames per second, or other suitable frame rate), a time variable may not be needed in the velocity calculation. In some cases, a time constant can be used (according to the instant frame rate) and/or a timestamp can be used.

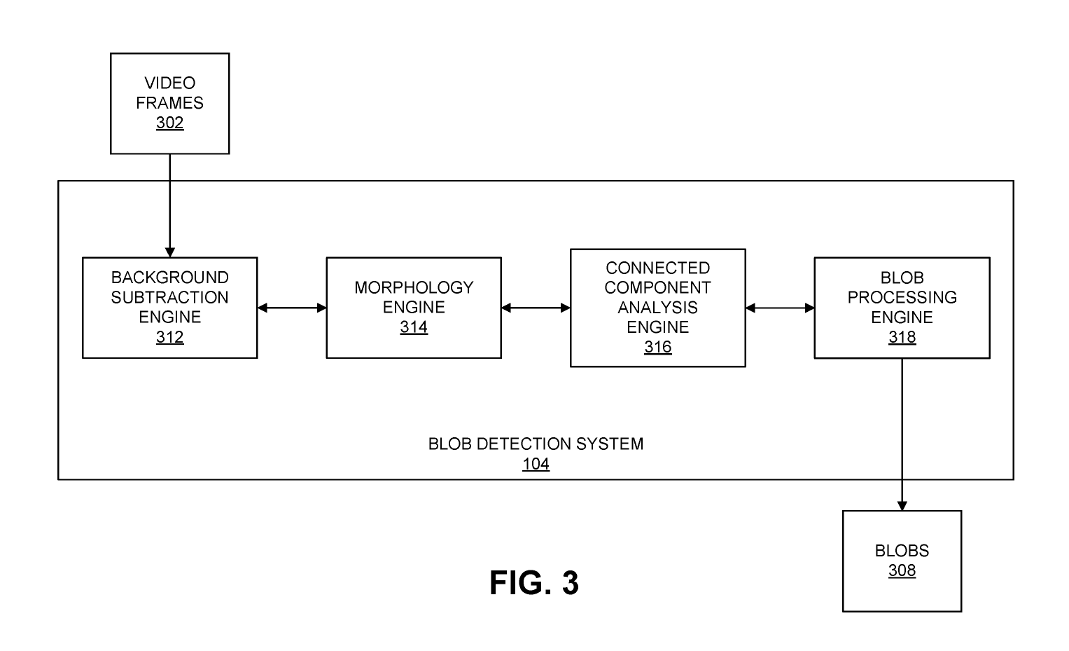

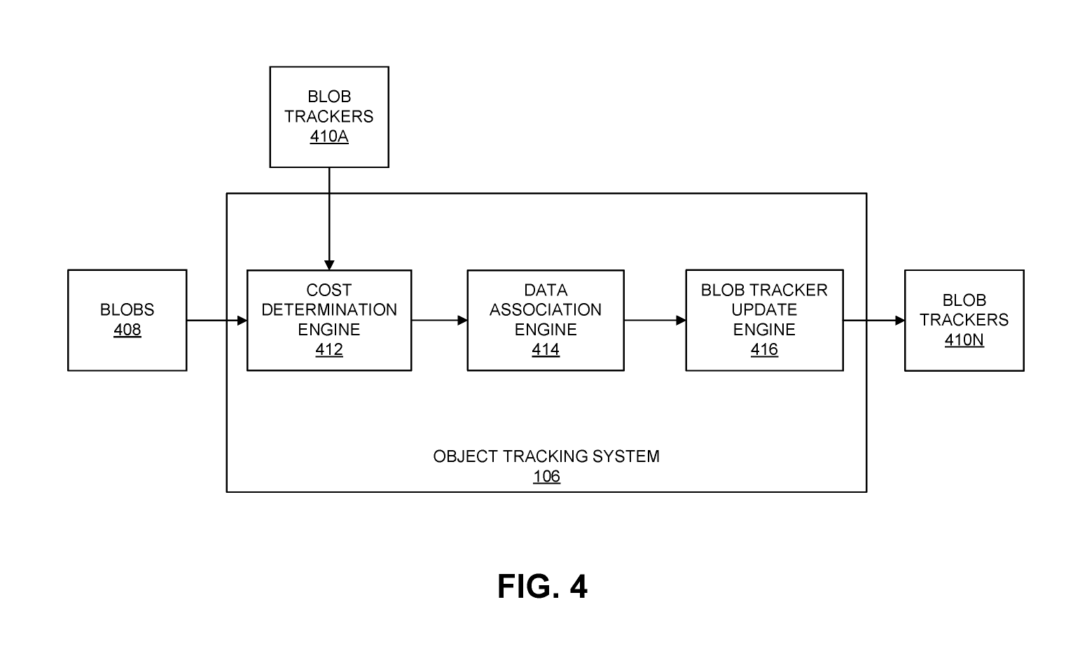

Using the blob detection system 104 and the object tracking system 106, the video analytics system 100 can perform blob generation and detection for each frame or picture of a video sequence. For example, the blob detection system 104 can perform background subtraction for a frame, and can then detect foreground pixels in the frame. Foreground blobs are generated from the foreground pixels using morphology operations and spatial analysis. Further, blob trackers from previous frames need to be associated with the foreground blobs in a current frame, and also need to be updated. Both the data association of trackers with blobs and tracker updates can rely on a cost function calculation. For example, when blobs are detected from a current input video frame, the blob trackers from the previous frame can be associated with the detected blobs according to a cost calculation. Trackers are then updated according to the data association, including updating the state and location of the trackers so that tracking of objects in the current frame can be fulfilled. Further details related to the blob detection system 104 and the object tracking system 106 are described with respect to FIGS. 3-4.

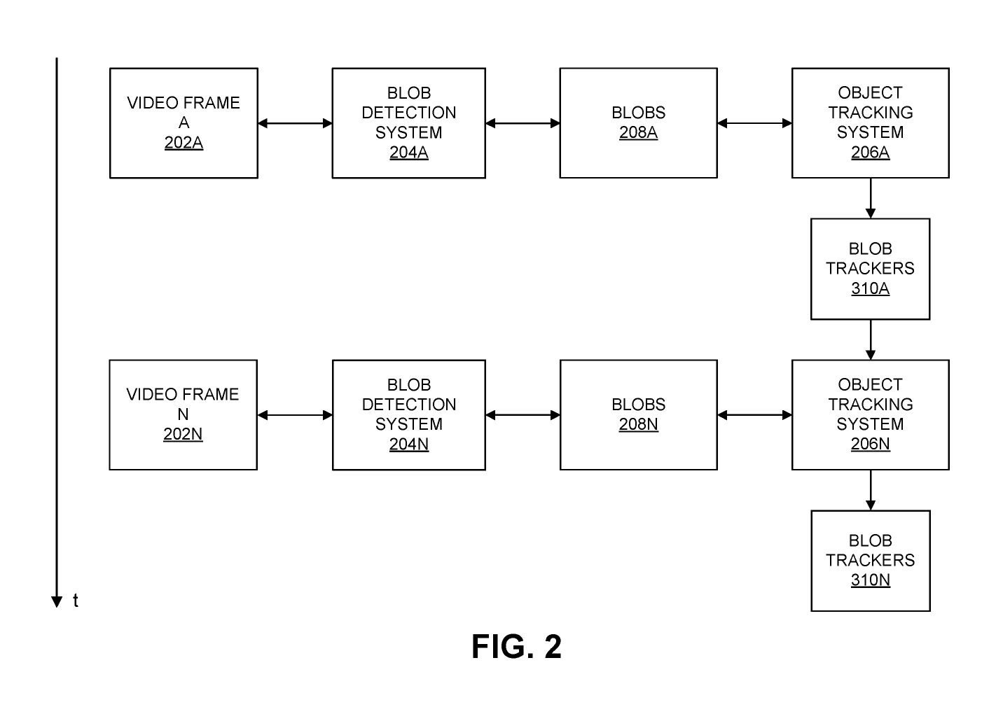

FIG. 2 is an example of the video analytics system (e.g., video analytics system 100) processing video frames across time t. As shown in FIG. 2, a video frame A 202A is received by a blob detection system 204A. The blob detection system 204A generates foreground blobs 208A for the current frame A 202A. After blob detection is performed, the foreground blobs 208A can be used for temporal tracking by the object tracking system 206A. Costs (e.g., a cost including a distance, a weighted distance, or other cost) between blob trackers and blobs can be calculated by the object tracking system 206A. The object tracking system 206A can perform data association to associate or match the blob trackers (e.g., blob trackers generated or updated based on a previous frame or newly generated blob trackers) and blobs 208A using the calculated costs (e.g., using a cost matrix or other suitable association technique). The blob trackers can be updated, including in terms of positions of the trackers, according to the data association to generate updated blob trackers 310A. For example, a blob tracker's state and location for the video frame A 202A can be calculated and updated. The blob tracker's location in a next video frame N 202N can also be predicted from the current video frame A 202A. For example, the predicted location of a blob tracker for the next video frame N 202N can include the location of the blob tracker (and its associated blob) in the current video frame A 202A. Tracking of blobs of the current frame A 202A can be performed once the updated blob trackers 310A are generated.

When a next video frame N 202N is received, the blob detection system 204N generates foreground blobs 208N for the frame N 202N. The object tracking system 206N can then perform temporal tracking of the blobs 208N. For example, the object tracking system 206N obtains the blob trackers 310A that were updated based on the prior video frame A 202A. The object tracking system 206N can then calculate a cost and can associate the blob trackers 310A and the blobs 208N using the newly calculated cost. The blob trackers 310A can be updated according to the data association to generate updated blob trackers 310N.

FIG. 3 is a block diagram illustrating an example of a blob detection system 104. Blob detection is used to segment moving objects from the global background in a scene. The blob detection system 104 includes a background subtraction engine 312 that receives video frames 302. The background subtraction engine 312 can perform background subtraction to detect foreground pixels in one or more of the video frames 302. For example, the background subtraction can be used to segment moving objects from the global background in a video sequence and to generate a foreground-background binary mask (referred to herein as a foreground mask). In some examples, the background subtraction can perform a subtraction between a current frame or picture and a background model including the background part of a scene (e.g., the static or mostly static part of the scene). Based on the results of background subtraction, the morphology engine 314 and connected component analysis engine 316 can perform foreground pixel processing to group the foreground pixels into foreground blobs for tracking purpose. For example, after background subtraction, morphology operations can be applied to remove noisy pixels as well as to smooth the foreground mask. Connected component analysis can then be applied to generate the blobs. Blob processing can then be performed, which may include further filtering out some blobs and merging together some blobs to provide bounding boxes as input for tracking.

The background subtraction engine 312 can model the background of a scene (e.g., captured in the video sequence) using any suitable background subtraction technique (also referred to as background extraction). One example of a background subtraction method used by the background subtraction engine 312 includes modeling the background of the scene as a statistical model based on the relatively static pixels in previous frames which are not considered to belong to any moving region. For example, the background subtraction engine 312 can use a Gaussian distribution model for each pixel location, with parameters of mean and variance to model each pixel location in frames of a video sequence. All the values of previous pixels at a particular pixel location are used to calculate the mean and variance of the target Gaussian model for the pixel location. When a pixel at a given location in a new video frame is processed, its value will be evaluated by the current Gaussian distribution of this pixel location. A classification of the pixel to either a foreground pixel or a background pixel is done by comparing the difference between the pixel value and the mean of the designated Gaussian model. In one illustrative example, if the distance of the pixel value and the Gaussian Mean is less than 3 times of the variance, the pixel is classified as a background pixel. Otherwise, in this illustrative example, the pixel is classified as a foreground pixel. At the same time, the Gaussian model for a pixel location will be updated by taking into consideration the current pixel value.

The background subtraction engine 312 can also perform background subtraction using a mixture of Gaussians (also referred to as a Gaussian mixture model (GMM)). A GMM models each pixel as a mixture of Gaussians and uses an online learning algorithm to update the model. Each Gaussian model is represented with mean, standard deviation (or covariance matrix if the pixel has multiple channels), and weight. Weight represents the probability that the Gaussian occurs in the past history.

$$P ( {X}_{t} ) = {\sum }_{i = 1}^{K} {ω}_{i , t} N ( {X}_{t} \vert {μ}_{i , t} , {Σ}_{i , t} ) \qquad Equation ( 1 )$$

An equation of the GMM model is shown in equation (1), wherein there are K Gaussian models. Each Guassian model has a distribution with a mean of μ and variance of Σ, and has a weight ω. Here, i is the index to the Gaussian model and t is the time instance. As shown by the equation, the parameters of the GMM change over time after one frame (at time t) is processed. In GMM or any other learning based background subtraction, the current pixel impacts the whole model of the pixel location based on a learning rate, which could be constant or typically at least the same for each pixel location. A background subtraction method based on GMM (or other learning based background subtraction) adapts to local changes for each pixel. Thus, once a moving object stops, for each pixel location of the object, the same pixel value keeps on contributing to its associated background model heavily, and the region associated with the object becomes background.

The background subtraction techniques mentioned above are based on the assumption that the camera is mounted still, and if anytime the camera is moved or orientation of the camera is changed, a new background model will need to be calculated. There are also background subtraction methods that can handle foreground subtraction based on a moving background, including techniques such as tracking key points, optical flow, saliency, and other motion estimation based approaches.

The background subtraction engine 312 can generate a foreground mask with foreground pixels based on the result of background subtraction. For example, the foreground mask can include a binary image containing the pixels making up the foreground objects (e.g., moving objects) in a scene and the pixels of the background. In some examples, the background of the foreground mask (background pixels) can be a solid color, such as a solid white background, a solid black background, or other solid color. In such examples, the foreground pixels of the foreground mask can be a different color than that used for the background pixels, such as a solid black color, a solid white color, or other solid color. In one illustrative example, the background pixels can be black (e.g., pixel color value 0 in 8-bit grayscale or other suitable value) and the foreground pixels can be white (e.g., pixel color value 255 in 8-bit grayscale or other suitable value). In another illustrative example, the background pixels can be white and the foreground pixels can be black.

Using the foreground mask generated from background subtraction, a morphology engine 314 can perform morphology functions to filter the foreground pixels. The morphology functions can include erosion and dilation functions. In one example, an erosion function can be applied, followed by a series of one or more dilation functions. An erosion function can be applied to remove pixels on object boundaries. For example, the morphology engine 314 can apply an erosion function (e.g., FilterErode3×3) to a 3×3 filter window of a center pixel, which is currently being processed. The 3×3 window can be applied to each foreground pixel (as the center pixel) in the foreground mask. One of ordinary skill in the art will appreciate that other window sizes can be used other than a 3×3 window. The erosion function can include an erosion operation that sets a current foreground pixel in the foreground mask (acting as the center pixel) to a background pixel if one or more of its neighboring pixels within the 3×3 window are background pixels. Such an erosion operation can be referred to as a strong erosion operation or a single-neighbor erosion operation. Here, the neighboring pixels of the current center pixel include the eight pixels in the 3×3 window, with the ninth pixel being the current center pixel.

A dilation operation can be used to enhance the boundary of a foreground object. For example, the morphology engine 314 can apply a dilation function (e.g., FilterDilate3×3) to a 3×3 filter window of a center pixel. The 3×3 dilation window can be applied to each background pixel (as the center pixel) in the foreground mask. One of ordinary skill in the art will appreciate that other window sizes can be used other than a 3×3 window. The dilation function can include a dilation operation that sets a current background pixel in the foreground mask (acting as the center pixel) as a foreground pixel if one or more of its neighboring pixels in the 3×3 window are foreground pixels. The neighboring pixels of the current center pixel include the eight pixels in the 3×3 window, with the ninth pixel being the current center pixel. In some examples, multiple dilation functions can be applied after an erosion function is applied. In one illustrative example, three function calls of dilation of 3×3 window size can be applied to the foreground mask before it is sent to the connected component analysis engine 316. In some examples, an erosion function can be applied first to remove noise pixels, and a series of dilation functions can then be applied to refine the foreground pixels. In one illustrative example, one erosion function with 3×3 window size is called first, and three function calls of dilation of 3×3 window size are applied to the foreground mask before it is sent to the connected component analysis engine 316. Details regarding content-adaptive morphology operations are described below.

After the morphology operations are performed, the connected component analysis engine 316 can apply connected component analysis to connect neighboring foreground pixels to formulate connected components and blobs. In some implementation of connected component analysis, a set of bounding boxes are returned in a way that each bounding box contains one component of connected pixels. One example of the connected component analysis performed by the connected component analysis engine 316 is implemented as follows:

for each pixel of the foreground mask {
-if it is a foreground pixel and has not been processed, the following steps
apply:

-Apply FloodFill function to connect this pixel to other foreground
and generate a connected component
-Insert the connected component in a list of connected components.
-Mark the pixels in the connected component as being processed }

The Floodfill (seed fill) function is an algorithm that determines the area connected to a seed node in a multi-dimensional array (e.g., a 2-D image in this case). This Floodfill function first obtains the color or intensity value at the seed position (e.g., a foreground pixel) of the source foreground mask, and then finds all the neighbor pixels that have the same (or similar) value based on 4 or 8 connectivity. For example, in a 4 connectivity case, a current pixel's neighbors are defined as those with a coordination being (x+d, y) or (x, y+d), wherein d is equal to 1 or −1 and (x, y) is the current pixel. One of ordinary skill in the art will appreciate that other amounts of connectivity can be used. Some objects are separated into different connected components and some objects are grouped into the same connected components (e.g., neighbor pixels with the same or similar values). Additional processing may be applied to further process the connected components for grouping. Finally, the blobs 308 are generated that include neighboring foreground pixels according to the connected components. In one example, a blob can be made up of one connected component. In another example, a blob can include multiple connected components (e.g., when two or more blobs are merged together).

The blob processing engine 318 can perform additional processing to further process the blobs generated by the connected component analysis engine 316. In some examples, the blob processing engine 318 can generate the bounding boxes to represent the detected blobs and blob trackers. In some cases, the blob bounding boxes can be output from the blob detection system 104. In some examples, there may be a filtering process for the connected components (bounding boxes). For instance, the blob processing engine 318 can perform content-based filtering of certain blobs. In some cases, a machine learning method can determine that a current blob contains noise (e.g., foliage in a scene). Using the machine learning information, the blob processing engine 318 can determine the current blob is a noisy blob and can remove it from the resulting blobs that are provided to the object tracking system 106. In some cases, the blob processing engine 318 can filter out one or more small blobs that are below a certain size threshold (e.g., an area of a bounding box surrounding a blob is below an area threshold). In some examples, there may be a merging process to merge some connected components (represented as bounding boxes) into bigger bounding boxes. For instance, the blob processing engine 318 can merge close blobs into one big blob to remove the risk of having too many small blobs that could belong to one object. In some cases, two or more bounding boxes may be merged together based on certain rules even when the foreground pixels of the two bounding boxes are totally disconnected. In some embodiments, the blob detection system 104 does not include the blob processing engine 318, or does not use the blob processing engine 318 in some instances. For example, the blobs generated by the connected component analysis engine 316, without further processing, can be input to the object tracking system 106 to perform blob and/or object tracking.

In some implementations, density based blob area trimming may be performed by the blob processing engine 318. For example, when all blobs have been formulated after post-filtering and before the blobs are input into the tracking layer, the density based blob area trimming can be applied. A similar process is applied vertically and horizontally. For example, the density based blob area trimming can first be performed vertically and then horizontally, or vice versa. The purpose of density based blob area trimming is to filter out the columns (in the vertical process) and/or the rows (in the horizontal process) of a bounding box if the columns or rows only contain a small number of foreground pixels.

The vertical process includes calculating the number of foreground pixels of each column of a bounding box, and denoting the number of foreground pixels as the column density. Then, from the left-most column, columns are processed one by one. The column density of each current column (the column currently being processed) is compared with the maximum column density (the column density of all columns). If the column density of the current column is smaller than a threshold (e.g., a percentage of the maximum column density, such as 10%, 20%, 30%, 50%, or other suitable percentage), the column is removed from the bounding box and the next column is processed. However, once a current column has a column density that is not smaller than the threshold, such a process terminates and the remaining columns are not processed anymore. A similar process can then be applied from the right-most column. One of ordinary skill will appreciate that the vertical process can process the columns beginning with a different column than the left-most column, such as the right-most column or other suitable column in the bounding box.

The horizontal density based blob area trimming process is similar to the vertical process, except the rows of a bounding box are processed instead of columns. For example, the number of foreground pixels of each row of a bounding box is calculated, and is denoted as row density. From the top-most row, the rows are then processed one by one. For each current row (the row currently being processed), the row density is compared with the maximum row density (the row density of all the rows). If the row density of the current row is smaller than a threshold (e.g., a percentage of the maximum row density, such as 10%, 20%, 30%, 50%, or other suitable percentage), the row is removed from the bounding box and the next row is processed. However, once a current row has a row density that is not smaller than the threshold, such a process terminates and the remaining rows are not processed anymore. A similar process can then be applied from the bottom-most row. One of ordinary skill will appreciate that the horizontal process can process the rows beginning with a different row than the top-most row, such as the bottom-most row or other suitable row in the bounding box.

One purpose of the density based blob area trimming is for shadow removal. For example, the density based blob area trimming can be applied when one person is detected together with his or her long and thin shadow in one blob (bounding box). Such a shadow area can be removed after applying density based blob area trimming, since the column density in the shadow area is relatively small. Unlike morphology, which changes the thickness of a blob (besides filtering some isolated foreground pixels from formulating blobs) but roughly preserves the shape of a bounding box, such a density based blob area trimming method can dramatically change the shape of a bounding box.

Once the blobs are detected and processed, object tracking (also referred to as blob tracking) can be performed to track the detected blobs. FIG. 4 is a block diagram illustrating an example of an object tracking system 106. The input to the blob/object tracking is a list of the blobs 408 (e.g., the bounding boxes of the blobs) generated by the blob detection system 104. In some cases, a tracker is assigned with a unique ID, and a history of bounding boxes is kept. Object tracking in a video sequence can be used for many applications, including surveillance applications, among many others. For example, the ability to detect and track multiple objects in the same scene is of great interest in many security applications. When blobs (making up at least portions of objects) are detected from an input video frame, blob trackers from the previous video frame need to be associated to the blobs in the input video frame according to a cost calculation. The blob trackers can be updated based on the associated foreground blobs. In some instances, the steps in object tracking can be conducted in a series manner.

A cost determination engine 412 of the object tracking system 106 can obtain the blobs 408 of a current video frame from the blob detection system 104. The cost determination engine 412 can also obtain the blob trackers 410A updated from the previous video frame (e.g., video frame A 202A). A cost function can then be used to calculate costs between the blob trackers 410A and the blobs 408. Any suitable cost function can be used to calculate the costs. In some examples, the cost determination engine 412 can measure the cost between a blob tracker and a blob by calculating the Euclidean distance between the centroid of the tracker (e.g., the bounding box for the tracker) and the centroid of the bounding box of the foreground blob. In one illustrative example using a 2-D video sequence, this type of cost function is calculated as below:

Cost_{tb}=\sqrt{(tₓ−bₓ)²+(t_{y}−b_{y})²}

The terms (tₓ, t_{y}) and (bₓ, b_{y}) are the center locations of the blob tracker and blob bounding boxes, respectively. As noted herein, in some examples, the bounding box of the blob tracker can be the bounding box of a blob associated with the blob tracker in a previous frame. In some examples, other cost function approaches can be performed that use a minimum distance in an x-direction or y-direction to calculate the cost. Such techniques can be good for certain controlled scenarios, such as well-aligned lane conveying. In some examples, a cost function can be based on a distance of a blob tracker and a blob, where instead of using the center position of the bounding boxes of blob and tracker to calculate distance, the boundaries of the bounding boxes are considered so that a negative distance is introduced when two bounding boxes are overlapped geometrically. In addition, the value of such a distance is further adjusted according to the size ratio of the two associated bounding boxes. For example, a cost can be weighted based on a ratio between the area of the blob tracker bounding box and the area of the blob bounding box (e.g., by multiplying the determined distance by the ratio).

In some embodiments, a cost is determined for each tracker-blob pair between each tracker and each blob. For example, if there are three trackers, including tracker A, tracker B, and tracker C, and three blobs, including blob A, blob B, and blob C, a separate cost between tracker A and each of the blobs A, B, and C can be determined, as well as separate costs between trackers B and C and each of the blobs A, B, and C. In some examples, the costs can be arranged in a cost matrix, which can be used for data association. For example, the cost matrix can be a 2-dimensional matrix, with one dimension being the blob trackers 410A and the second dimension being the blobs 408. Every tracker-blob pair or combination between the trackers 410A and the blobs 408 includes a cost that is included in the cost matrix. Best matches between the trackers 410A and blobs 408 can be determined by identifying the lowest cost tracker-blob pairs in the matrix. For example, the lowest cost between tracker A and the blobs A, B, and C is used to determine the blob with which to associate the tracker A.

Data association between trackers 410A and blobs 408, as well as updating of the trackers 410A, may be based on the determined costs. The data association engine 414 matches or assigns a tracker (or tracker bounding box) with a corresponding blob (or blob bounding box) and vice versa. For example, as described previously, the lowest cost tracker-blob pairs may be used by the data association engine 414 to associate the blob trackers 410A with the blobs 408. Another technique for associating blob trackers with blobs includes the Hungarian method, which is a combinatorial optimization algorithm that solves such an assignment problem in polynomial time and that anticipated later primal-dual methods. For example, the Hungarian method can optimize a global cost across all blob trackers 410A with the blobs 408 in order to minimize the global cost. The blob tracker-blob combinations in the cost matrix that minimize the global cost can be determined and used as the association.

In addition to the Hungarian method, other robust methods can be used to perform data association between blobs and blob trackers. For example, the association problem can be solved with additional constraints to make the solution more robust to noise while matching as many trackers and blobs as possible. Regardless of the association technique that is used, the data association engine 414 can rely on the distance between the blobs and trackers.

Once the association between the blob trackers 410A and blobs 408 has been completed, the blob tracker update engine 416 can use the information of the associated blobs, as well as the trackers' temporal statuses, to update the status (or states) of the trackers 410A for the current frame. Upon updating the trackers 410A, the blob tracker update engine 416 can perform object tracking using the updated trackers 410N, and can also provide the updated trackers 410N for use in processing a next frame.

The status or state of a blob tracker can include the tracker's identified location (or actual location) in a current frame and its predicted location in the next frame. The location of the foreground blobs are identified by the blob detection system 104. However, as described in more detail below, the location of a blob tracker in a current frame may need to be predicted based on information from a previous frame (e.g., using a location of a blob associated with the blob tracker in the previous frame). After the data association is performed for the current frame, the tracker location in the current frame can be identified as the location of its associated blob(s) in the current frame. The tracker's location can be further used to update the tracker's motion model and predict its location in the next frame. Further, in some cases, there may be trackers that are temporarily lost (e.g., when a blob the tracker was tracking is no longer detected), in which case the locations of such trackers also need to be predicted (e.g., by a Kalman filter). Such trackers are temporarily not shown to the system. Prediction of the bounding box location helps not only to maintain certain level of tracking for lost and/or merged bounding boxes, but also to give more accurate estimation of the initial position of the trackers so that the association of the bounding boxes and trackers can be made more precise.

As noted above, the location of a blob tracker in a current frame may be predicted based on information from a previous frame. One method for performing a tracker location update is using a Kalman filter. The Kalman filter is a framework that includes two steps. The first step is to predict a tracker's state, and the second step is to use measurements to correct or update the state. In this case, the tracker from the last frame predicts (using the blob tracker update engine 416) its location in the current frame, and when the current frame is received, the tracker first uses the measurement of the blob(s) (e.g., the blob(s) bounding box(es)) to correct its location states and then predicts its location in the next frame. For example, a blob tracker can employ a Kalman filter to measure its trajectory as well as predict its future location(s). The Kalman filter relies on the measurement of the associated blob(s) to correct the motion model for the blob tracker and to predict the location of the object tracker in the next frame. In some examples, if a blob tracker is associated with a blob in a current frame, the location of the blob is directly used to correct the blob tracker's motion model in the Kalman filter. In some examples, if a blob tracker is not associated with any blob in a current frame, the blob tracker's location in the current frame is identified as its predicted location from the previous frame, meaning that the motion model for the blob tracker is not corrected and the prediction propagates with the blob tracker's last model (from the previous frame).

Other than the location of a tracker, the state or status of a tracker can also, or alternatively, include a tracker's temporal state or status. The temporal state of a tracker can include a new state indicating the tracker is a new tracker that was not present before the current frame, a normal state for a tracker that has been alive for a certain duration and that is to be output as an identified tracker-blob pair to the video analytics system, a lost state for a tracker that is not associated or matched with any foreground blob in the current frame, a dead state for a tracker that fails to associate with any blobs for a certain number of consecutive frames (e.g., two or more frames, a threshold duration, or the like), and/or other suitable temporal status. Another temporal state that can be maintained for a blob tracker is a duration of the tracker. The duration of a blob tracker includes the number of frames (or other temporal measurement, such as time) the tracker has been associated with one or more blobs.

There may be other state or status information needed for updating the tracker, which may require a state machine for object tracking. Given the information of the associated blob(s) and the tracker's own status history table, the status also needs to be updated. The state machine collects all the necessary information and updates the status accordingly. Various statuses of trackers can be updated. For example, other than a tracker's life status (e.g., new, lost, dead, or other suitable life status), the tracker's association confidence and relationship with other trackers can also be updated. Taking one example of the tracker relationship, when two objects (e.g., persons, vehicles, or other objects of interest) intersect, the two trackers associated with the two objects will be merged together for certain frames, and the merge or occlusion status needs to be recorded for high level video analytics.

Regardless of the tracking method being used, a new tracker starts to be associated with a blob in one frame and, moving forward, the new tracker may be connected with possibly moving blobs across multiple frames. When a tracker has been continuously associated with blobs and a duration (a threshold duration) has passed, the tracker may be promoted to be a normal tracker. A normal tracker is output as an identified tracker-blob pair. For example, a tracker-blob pair is output at the system level as an event (e.g., presented as a tracked object on a display, output as an alert, and/or other suitable event) when the tracker is promoted to be a normal tracker. In some implementations, a normal tracker (e.g., including certain status data of the normal tracker, the motion model for the normal tracker, or other information related to the normal tracker) can be output as part of object metadata. The metadata, including the normal tracker, can be output from the video analytics system (e.g., an IP camera running the video analytics system) to a server or other system storage. The metadata can then be analyzed for event detection (e.g., by rule interpreter). A tracker that is not promoted as a normal tracker can be removed (or killed), after which the tracker can be considered as dead.

As noted above, blob trackers can have various temporal states, such as a new state for a tracker of a current frame that was not present before the current frame, a lost state for a tracker that is not associated or matched with any foreground blob in the current frame, a dead state for a tracker that fails to associate with any blobs for a certain number of consecutive frames (e.g., 2 or more frames, a threshold duration, or the like), a normal state for a tracker that is to be output as an identified tracker-blob pair to the video analytics system, or other suitable tracker states. Another temporal state that can be maintained for a blob tracker is a duration of the tracker. The duration of a blob tracker includes the number of frames (or other temporal measurement, such as time) the tracker has been associated with one or more blobs.

A blob tracker can be promoted or converted to be a normal tracker when certain conditions are met. A tracker is given a new state when the tracker is created and its duration of being associated with any blobs is 0. The duration of the blob tracker can be monitored, as well as its temporal state (new, lost, hidden, or the like). As long as the current state is not hidden or lost, and as long as the duration is less than a threshold duration T1, the state of the new tracker is kept as a new state. A hidden tracker may refer to a tracker that was previously normal (thus independent), but later merged into another tracker C. In order to enable this hidden tracker to be identified later due to the anticipation that the merged object may be split later, it is still kept as associated with the other tracker C which is containing it.

The threshold duration T1 is a duration that a new blob tracker must be continuously associated with one or more blobs before it is converted to a normal tracker (transitioned to a normal state). The threshold duration can be a number of frames (e.g., at least N frames) or an amount of time. In one illustrative example, a blob tracker can be in a new state for 30 frames (corresponding to one second in systems that operate using 30 frames per second), or any other suitable number of frames or amount of time, before being converted to a normal tracker. If the blob tracker has been continuously associated with blobs for the threshold duration (duration>T1), the blob tracker is converted to a normal tracker by being transitioned from a new status to a normal status

If, during the threshold duration T1, the new tracker becomes hidden or lost (e.g., not associated or matched with any foreground blob), the state of the tracker can be transitioned from new to dead, and the blob tracker can be removed from blob trackers maintained for a video sequence (e.g., removed from a buffer that stores the trackers for the video sequence).

In some examples, objects may intersect or group together, in which case the blob detection system can detect one blob (a merged blob) that contains more than one object of interest (e.g., multiple objects that are being tracked). For example, as a person walks near another person in a scene, the bounding boxes for the two persons can become a merged bounding box (corresponding to a merged blob). The merged bounding box can be tracked with a single blob tracker (referred to as a container tracker), which can include one of the blob trackers that was associated with one of the blobs making up the merged blob, with the other blob(s)' trackers being referred to as merge-contained trackers. For example, a merge-contained tracker is a tracker (new or normal) that was merged with another tracker when two blobs for the respective trackers are merged, and thus became hidden and carried by the container tracker.

A tracker that is split from an existing tracker is referred to as a split-new tracker. The tracker from which the split-new tracker is split is referred to as a parent tracker or a split-from tracker. In some examples, a split-new tracker can result from the association (or matching or mapping) of multiple blobs to one active tracker. For instance, a split-new tracker can result when an object is detected as multiple separate blobs, in which case the multiple blobs are associated (or matched or mapped) to one active tracker. Typically, one active tracker can only be mapped to one blob. All the other blobs (the blobs remaining from the multiple blobs that are not mapped to the tracker) cannot be mapped to any existing trackers. In such examples, new trackers will be created for the other blobs, and these new trackers are assigned the state “split-new.” Such a split-new tracker can be referred to as the child tracker of the original tracker its associated blob is mapped to. The corresponding original tracker can be referred to as the parent tracker (or the split-from tracker) of the child tracker. In some examples, a split-new tracker can also result from a merge-contained tracker. As noted above, a merge-contained tracker is a tracker that was merged with another tracker (when two blobs for the respective trackers are merged) and thus became hidden and carried by the container tracker. A merge-contained tracker can be split from the container tracker if the container tracker is active and the container tracker has a mapped blob in the current frame.

In some cases, a video analytics system can encounter problems when attempting to track certain objects. For example, when multiple objects are detected as a single blob (a merge situation) and are tracked as a single object due to the merge situation, the video analytics system can have difficulties tracking the individual objects detected in the merged blob. For instance, only a single tracker (and bounding box) may be able to be associated with the merged blob. In another example, when a split occurs after a merge situation (e.g., two people walk away from each other), the video analytics system may incorrectly identify which trackers to associate with the objects. Such tracking difficulty can be exacerbated if multiple objects are merged for a long period of time, or if multiple merge situations occur over time. Further, in some cases, the video analytics system may detect false positive objects due to the nature of blob detection detecting moving objects. False positive objects can include background objects that should not be tracked, including moving foliage due to wind or other external event, an object (e.g., umbrella, flag, balloon, or other object) that is generally static but has some movement due to external elements (e.g., wind, a person brushing the object, or other cause), glass doors, objects detected due to lighting condition changes, isolated shadows, objects detected due to shadows of real objects, and any other types of background objects that may have movement. False positive objects are common and can have a serious impact on the performance of the video analytics system. For instance, tracking of false positive objects can cause the system to trigger false alarms.

Machine learning systems utilizing neural networks can also be used to classify (or detect) objects in one or more video frames of a video sequence. For example, deep learning networks (also referred to herein as deep networks and deep neural networks) can be used to classify and/or localize objects in a video frame. A deep learning network can identify objects in a video frame based on knowledge gleaned from training images (or other data) that include similar objects and labels indicating the classification of those objects. A trained neural network can be referred to herein as a trained network or a trained neural network.

A neural network can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the network includes feature maps or activation maps that can include nodes. A feature map can include a filter, a kernel, or the like. The nodes can include one or more weights used to indicate an importance of the nodes of one or more of the layers. In some cases, a deep learning network can have a series of many hidden layers, with early layers being used to determine simple and low level characteristics of an input, and later layers building up a hierarchy of more complex and abstract characteristics. For a classification network, the deep learning system can classify an object in a video frame using the determined high-level features. The output can be a single class or category, a probability of classes that best describes the object, or other suitable output. For example, the output can include probability values indicating probabilities that the object includes one or more classes of objects (e.g., a probability the object is a person, a probability the object is a dog, a probability the object is a cat, or the like).

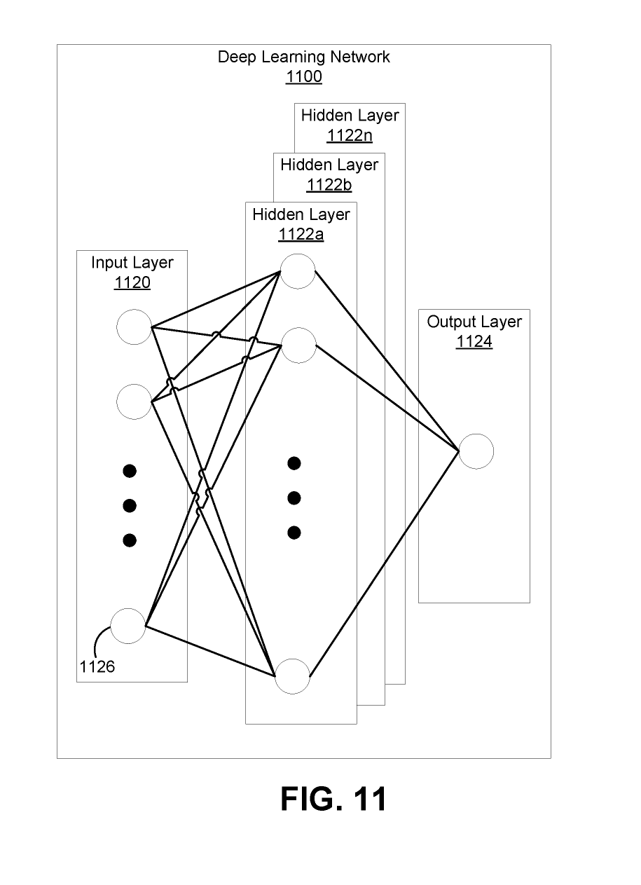

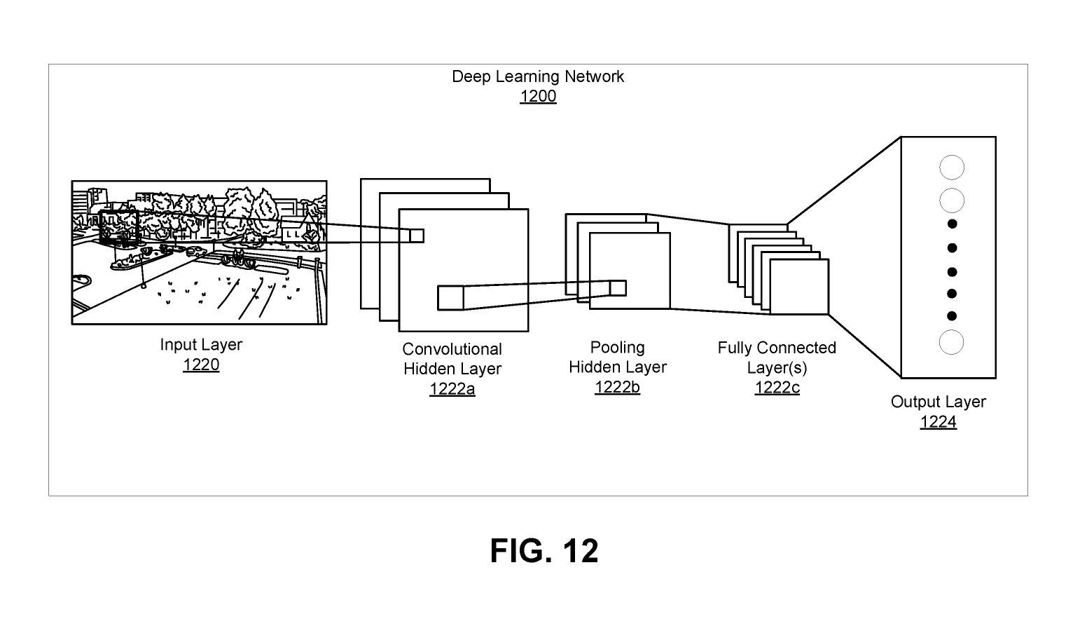

As noted above, nodes in the input layer can represent input data, nodes in the one or more hidden layers can represent computations, and nodes in the output layer can represent results from the one or more hidden layers. In one illustrative example, a deep learning neural network can be used to determine whether an object in a video frame is a person. In such an example, nodes in an input layer of the network can include normalized values for pixels of an image (e.g., with one node representing one normalized pixel value), nodes in a hidden layer can be used to determine whether certain common features of a person are present (e.g., two legs are present, a face is present at the top of the object, two eyes are present at the top left and top right of the face, a nose is present in the middle of the face, a mouth is present at the bottom of the face, and/or other features common for a person), and nodes of an output layer can indicate whether a person is classified and/or detected or not. This example network can have a series of many hidden layers, with early layers determining low-level features of the object in the video frame (e.g., curves, edges, and/or other low-level features), and later layers building up a hierarchy of more high-level and abstract features of the object (e.g., legs, a head, a face, a nose, eyes, mouth, and/or other features). Based on the determined high-level features, the deep learning network can classify the object as being a person or not (e.g., based on a probability of the object being a person relative to a threshold value). Further details of the structure and function of neural networks are described below with respect to FIG. 11 and FIG. 12.

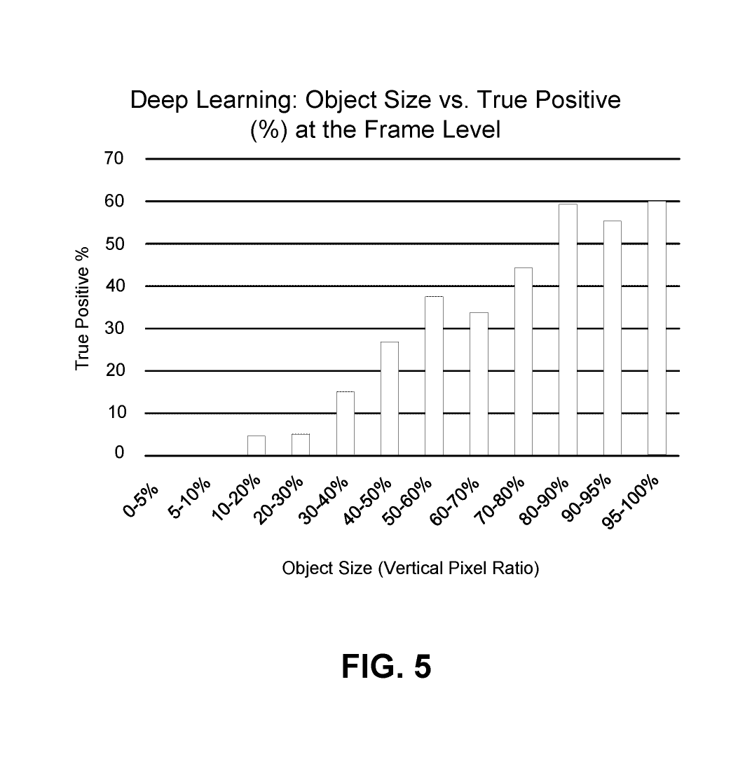

Deep learning networks can also have issues when being used to classify and/or localize objects in a video sequence. For example, deep learning can perform poorly when an object is small relative to the height of the video frame, making it difficult to obtain an all-range classification for objects in the near and far range (or depth) of the image frame. FIG. 5 is a chart illustrating object size versus true positive rate for a deep learning system at the frame level. As shown, for large objects that are greater than 80% of the video frame height, the true positive detection rate is around 60%. However, for small objects that are less than 30% of the video frame height, the true positive detection rate is drastically reduced to below 10%. The chart shown in FIG. 5 was generated from 250 videos in all cases.

Another issue for deep learning networks is that a large number of hidden layers are required to classify an object in an image or video frame. The complexity of a neural network is even higher when attempting to classify small objects. Such a large number of hidden layers causes increased processing times that are insufficient for classifying objects in a video sequence in real-time.

Systems and methods are described herein that can perform all-range object classification in real-time, while providing the benefits of both video analytics-based object tracking and deep learning networks. The term “real-time” refers to classifying objects in a video sequence as the video sequence is being captured. To obtain all-range object classification in real-time, object detection and tracking can be used along with deep learning-based classification to generate accurate and efficient object tracking results. Instead of applying a deep learning process to an entire video frame, the object classification systems and methods described herein can use only one or more regions of interest in a video frame to generate the input to the deep learning system. For example, an image of the original video frame can be cropped using a region of interest. The one or more regions of interest are identified using one or more bounding boxes (or other suitable bounding region) provided from object tracking. Using a cropped image makes it possible to have a higher resolution frame fed into the deep learning network.

In one example of using an entire video frame, an input to a video analytics system is a 1080 p video frame, and without extracting regions of interest from the frame, the whole frame is downsampled to a smaller resolution (e.g., 512×512, 320×320, or the like), causing small objects to be missed by the deep learning system. Using the proposed techniques described herein, an area (e.g., an area of 200×200) can be extracted according to one or more bounding boxes provided from the object tracking system, and by accessing a co-located area in a high resolution input (e.g., a 4K video frame), very small objects can be detected by the deep learning system. In some cases, the deep learning system can be invoked only if the output of the object tracking system indicates or implies the possibility of having new objects or new unassociated regions of interest detected for a current video frame. In some cases, to process the current video frame using deep learning with a lower frequency, one or more regions of interest can be buffered in a queue, so that later on, the deep learning engine may check regions of interest from the already processed frames to classify a tracked blob which has not been classified yet.

By applying a combined object tracking and deep learning system, the problems described above can be avoided. For example, by utilizing cropped portions of a video frame when applying a deep learning network, small objects can be accurately classified due to the objects taking up a much larger proportion of the cropped image than that occupied in the original image. Furthermore, even when objects detected by the object detection system are merged together, the deep learning system can identify and locate the individual objects that are included in a merged blob because deep learning identifies unique features of each object. In another example, background objects that are detected and tracked as false positive objects by object detection and tracking can be correctly classified by the deep learning system (e.g., as a tree, as a shadow, or other background object that might periodically move), which can then be used by the video analytics system to identify the objects as background. Many other advantages also result from the real-time, all-range object classification systems and processes described herein.

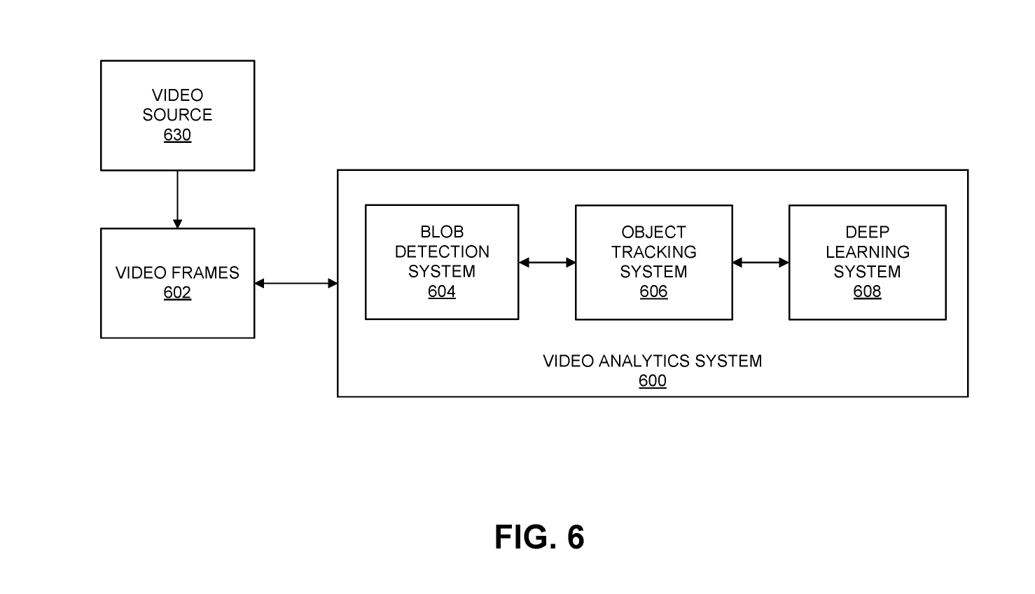

FIG. 6 is an example of a video analytics system 600 that can be used to perform an all-range object classification process in real-time using object detection/tracking and deep learning-based classification. The video analytics system 600 includes a blob detection system 604, an object tracking system 606, and a deep learning system 608. The object detection system 604 is similar to and can perform the same operations as the object detection system 104 described above. For example, the object detection system 604 can receive video frames 602 of a video sequence provided by a video source 630. The object detection system 604 can perform object detection to detect one or more blobs (representing one or more objects) for the video frames 602. The object tracking system 606 is similar to and can perform the same operations as the object tracking system 106 described above. For example, the object tracking system 606 can associate trackers and corresponding bounding boxes with the one or more blobs detected by the object detection system 604.

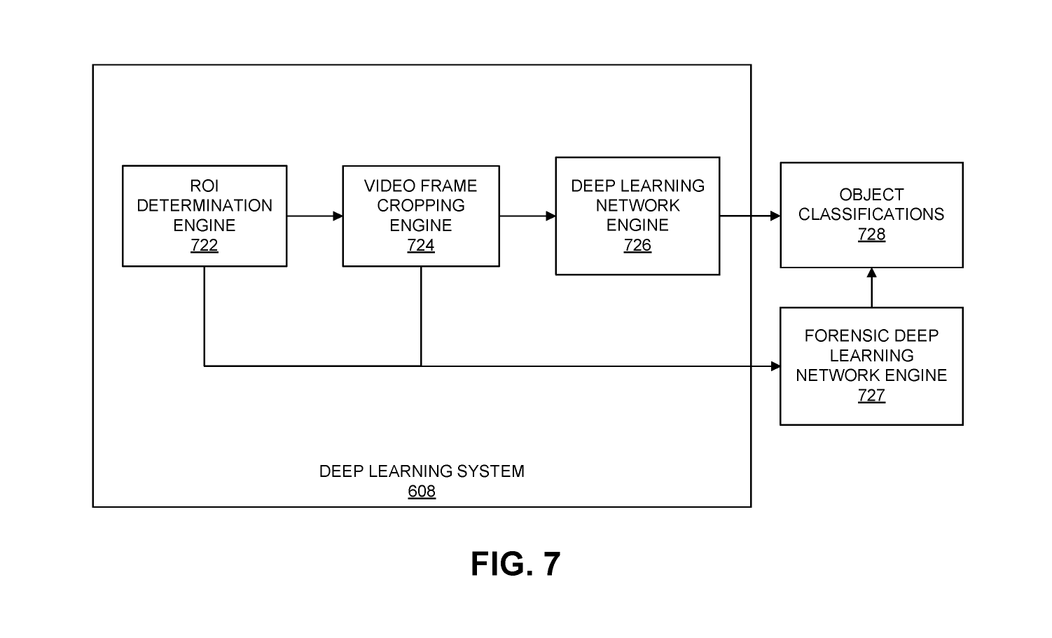

The bounding boxes assigned to the one or more blobs by the object tracking system 606 can be periodically output to the deep learning system 608. FIG. 7 is a diagram illustrating an example of the deep learning system 608. The deep learning system 608 includes a region of interest (ROI) determination engine 722 that can determine one or more ROIs from the bounding boxes provided from the object tracking system 606. The video frame cropping engine 724 can crop the part of an original full video frame corresponding to the one or more ROIs. For example, the area corresponding to the one or more ROIs can be cropped from the original frame to provide one or more cropped frames or images corresponding to the one or more ROIs. The one or more cropped images can then be provided to the deep learning network engine 726 and/or the forensic deep learning network engine 727, depending on statuses of one or more objects within the one or more ROIs. The deep learning network engine 726 and the forensic deep learning network engine 727 can apply different deep learning networks to a cropped image (cropped according to an ROI in the entire video frame), instead of the entire video frame, to classify and localize one or more objects that are located in the cropped image.

The outputs from the deep learning network engine 726 and the forensic deep learning network engine 727 can include object classifications 728 for one or more of the objects in the cropped ROIs. The outputs can also include bounding boxes identifying the location of the classified objects. In some examples, the forensic deep learning network engine 727 can be part of the deep learning system 608 (e.g., included in a common piece of hardware, such as one or more chips, and/or a common set of software code). In some examples, the forensic deep learning network engine 727 can be a separate component from the deep learning system 608 (e.g., a separate piece of hardware, such as one or more chips, and/or a separate set of software code), as shown in FIG. 7. Example deep learning networks are described with respect to FIG. 11 and FIG. 12.

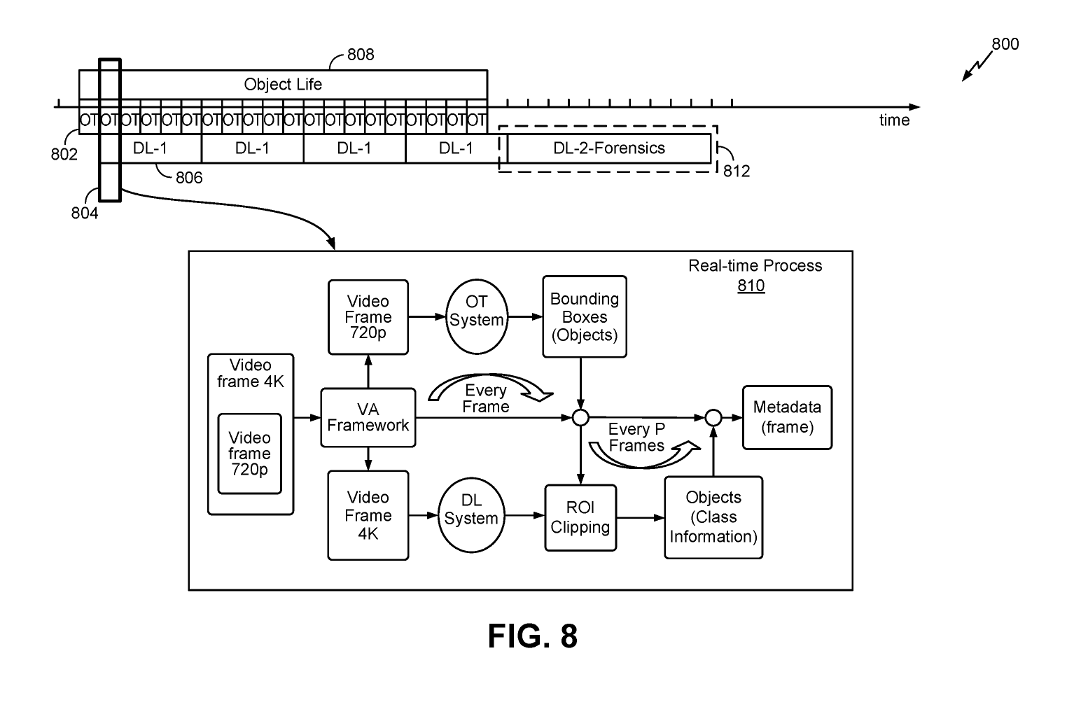

FIG. 8 is a diagram illustrating an example of a data flow 800 for an object classification process performed by the video analytics system 600. As shown, the video analytics system 600 can perform object detection and tracking at every video frame 802 of the video sequence to detect and track objects in the video frames. Object detection and tracking is denoted as OT in FIG. 8. Each “OT” block shown in FIG. 8 indicates a frame of the video sequence for which object detection and tracking is applied. Object detection and tracking can be performed using the techniques described above with respect to FIG. 1-FIG. 4. In some implementations, object detection and tracking may not be performed for every video frame of the video sequence. For example, object detection and tracking may be performed for every other video frame or for some other suitable number of video frames.

A first deep learning process (DL-1) is first applied at a given frame and can then be performed again every P number of frames after the given frame, where P is an integer value greater than or equal to 1. As described in more detail herein, the DL-1 process can utilize a first trained network (e.g., a first deep learning classification network) to classify and/or localize one or more objects in one or more of the video frames. The period P at which the DL-1 process is performed can depend on the amount of time the DL-1 process is designed to run on a given video frame. The amount to time can be fixed so that it takes P number of frames for every iteration of the DL-1 process. The value of P will typically be greater than one video frame due to the DL-1 process requiring multiple video frames to classify and localize objects in the regions of interest (ROIs) determined from the bounding boxes provided from object tracking.

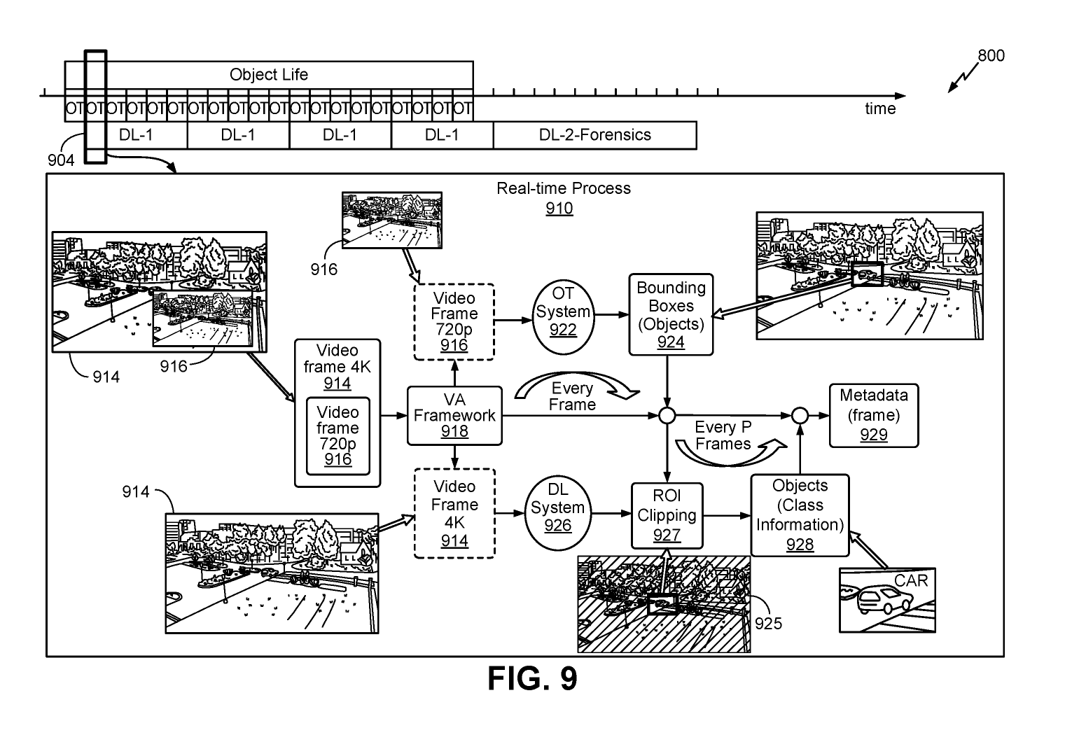

As shown in FIG. 8, the value of P is equal to 5, such that the DL-1 process takes five frames to complete the deep learning process for a frame. For example, a first iteration 806 of the DL-1 process can be invoked at the second frame of the video sequence, as shown by the box 804, and can be applied again five frames later (at the seventh frame). The DL-1 process is not invoked at the first frame because at least one frame needs to be processed by the object detection and tracking systems to determine bounding boxes that will be output to the deep learning system for use by the DL-1 process. The DL-1 process can finish processing the ROIs of the second frame by the end of the sixth video frame, at which point the DL-1 process can be invoked again at the seventh video frame. An illustration of the real-time process 810 including object detection/tracking and the DL-1 process is shown in FIG. 8. The real-time process is described in more detail with respect to FIG. 9.

In some cases, for a given image of a scene, a video frame used by object detection and tracking can have a lower resolution (e.g., 720 p resolution) than the resolution of a video frame used by the deep learning system (e.g., 4K resolution). The two video frames can be considered as being different versions of the same video frame such that the two video frames include the same image of the scene, but at different resolutions. In some cases, the lower resolution video frame used by the object detection and tracking systems can be a downsampled version of the higher resolution video frame used by the deep learning system. The DL-1 process uses a higher resolution frame, which benefits a deep learning network when trying to classify objects in the image of the high resolution frame. The DL-2 Forensic process described below can also use the high resolution video frame. The higher resolution image is also beneficial to the deep learning system because, as described in more detail below, the original image in the video frame is cropped. Having a higher resolution allows the cropped frame to have more details (due to more pixels being present) than if the video frame had a lower resolution. Cropping of the image reduces and can eliminate the problem deep learning systems have with respect to small objects because an object will be increased in size relative to the frame height due to the object remaining the same size and the cropped frame becoming smaller, effectively leading to the object becoming larger relative to the frame height. That is, cropping of the frame allows the system to analyze a bigger object relative to the frame size. The object detection and tracking processes can operate on a lower resolution frame because the processes are based on detection and tracking of blobs that include groupings of foreground pixels. In other cases, the object detection/tracking system and the deep learning system can use a single video frame (having a single resolution), instead of video frames having differing resolutions.

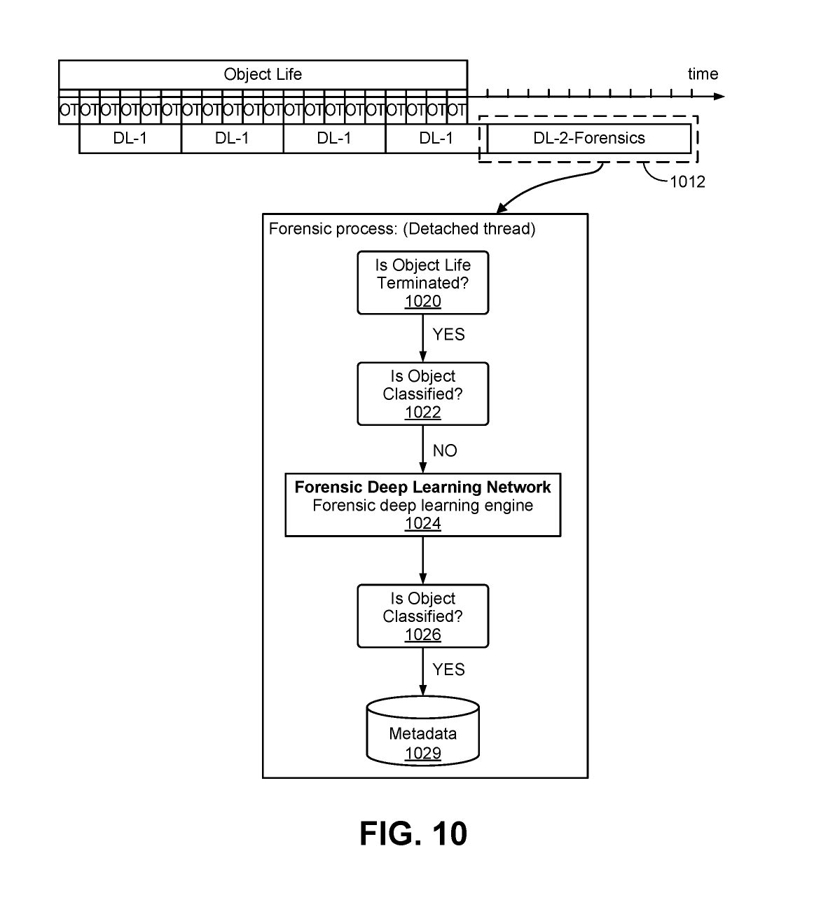

The DL-1 process can continue to be applied for an object until an object life 808 of the object comes to an end. An object's life is considered to come to an end when a blob representing the object is no longer detected and/or tracked in the video sequence by the video analytics system (e.g., the object is considered to have a lost status, or other indication that the object is no longer present). For example, a person being tracked may leave the scene being captured in the video sequence, and thus may no longer be detected and tracked by the video analytics system. When an object's life ends, a second deep learning forensic process (DL-2 Forensics 812) can be applied to a ROI containing the object by the forensic deep learning network engine 727. As described in more detail herein, the DL-2 process can utilize a second trained network (e.g., a second deep learning classification network) to classify and/or localize one or more objects in one or more of the video frames. The DL-2 Forensics process is described in more detail below with respect to FIG. 10.

FIG. 9 is a diagram of the data flow 800 with visual representations of the different steps of the real-time object detection process 910 performed by the video analytics system 600. At the second frame of the video sequence (as indicated by block 904), a first iteration of the real-time process 910 is invoked. The second video frame is referred to as the current video frame, which is the video frame that is currently being processed by the video analytics system 600. As shown, a video frame 914 having a first resolution (4K in the example of FIG. 9) is provided to a video analytics (VA) framework engine 918 along with a video frame 916 having a second resolution (720 p in the example of FIG. 9). In some examples, the video frame 916 can be a downsampled version of the video frame 914, and can be generated using any suitable downsampling technique. In some examples, the video frame 914 can be a separate video frame than the video frame 916, in which case the video frames 914 and 916 capture the same scene at the same instance of time and from the same perspective (the same angle and orientation). In any event, the video frame 914 and the video frame 916 capture the same image of the scene and can thus be considered as being different versions of the same current video frame (one having a lower resolution than the other) that is being processed by the real-time process 910.

The VA framework engine 918 can process the video frames 914 and 916 to determine which component of the video analytics system 600 will be provided with the video frames 914 and 916. The lower resolution video frame 916 is provided to the object detection and tracking system 922 (OT 922). The OT system 922 can perform object detection to determine one or more foreground blobs for the video frame 916. Object tracking can then be performed to associate (or match) object trackers with the one or more blobs. The blob detection and object tracking processes performed by the OT system 922 can be performed by the blob detection 604 and the object tracking system 606, and are described in further detail above with respect to FIG. 1-FIG. 4.

Using the techniques described above, bounding boxes 924 are maintained for the trackers and are used to track the blobs (representing the objects) detected for the current video frame. The OT system 922 can output the bounding boxes 924 to the deep learning (DL) system 926. The DL system 926 is similar to and can perform the same operations as the deep learning system 608 described above. Tracker identifiers (IDs) can also be maintained for the trackers and can be associated with the bounding boxes so that tracked objects can be identified by the video analytics system 600. The tracker IDs are included in object metadata maintained for the current video frame being processed (as noted above, frames 914 and 916 are different versions of the current video frame). The tracker bounding boxes 924 identify the locations of the various objects (blobs) that have been detected and tracked in the video frame 916. The bounding boxes 924 can be used by the DL system 926 to identify one or more regions of interest (ROIs) in the high resolution video frame 914, which can then be used for application of a trained network (e.g., a deep learning neural network).

The bounding boxes generated using the lower resolution video frame 916 can be converted to bounding boxes for the higher resolution video frame 914 to account for the different sizes of the video frames 914 and 916. In some implementations, coordination of the bounding boxes between the different resolution video frames can be performed using a scaled relevant number (e.g., between 0-10000 or other suitable value) so that the bounding boxes can be positioned correctly in the different resolution frames. For example, the VA framework engine 918 can save a scaled relevant number (0-10000) for each bounding box to perform the coordination. A scaled relevant number can be denoted as (x, y, width, height), with an illustrative example being (7000, 8000, 1000, 400). A scaled relevant number can be independent from the resolution. In one illustrative example using 10000 as a scaled relevant number, a position (640, 360) of a bounding box in a higher resolution frame, for example having 1280×720 resolution, would have a scaled value of (640/1280*10000, 360/720*10000)=(5000, 5000) in the VA framework 918. The position (640, 360) can include any point on the bounding box, such as a center point, a top-left corner, a top-right corner, a bottom-left corner, a bottom-right corner, or other suitable point. When the bounding box position is converted to a lower resolution frame, for example having 640×480 resolution, the bounding box would get converted back using the VA framework engine 918 coordination—a corresponding (5000/10000*640, 5000/10000*480)=(320, 240), relating to a corresponding position in the lower resolution frame. The same type of conversion can be performed when going from a low resolution frame to a higher resolution frame.

In some cases, the DL system 926 can define an ROI for the higher resolution frame 914 so that the ROI encompasses as many bounding boxes as possible, given the size of the ROI. For example, if a single object is detected and a bounding box representing that object is provided to the DL system 926, an ROI can be generated that corresponds to the size of the bounding box. In such an example, the ROI can be the same size as the bounding box or can be larger than the bounding box. The size of the ROI can depend on the design of the system, and can be configurable based on system requirements. In another example, if multiple bounding boxes are provided to the DL system 926, indicating that multiple objects have been detected and tracked, the DL system 926 can generate an ROI that covers as many of the multiple bounding boxes as possible.

In some implementations, the ROIs generated by the DL system 926 can have a fixed size. A fixed-size ROI allows the video analytics system 600 to set a pre-defined duration for the DL-1 process to process a video frame. For instance, the pre-defined duration allows the DL-1 process to be consistently performed every P video frames, as described above. In one illustrative example, if multiple bounding boxes are provided to the DL system 926, a fixed size ROI can be generated that covers as many of the bounding boxes as possible, given the fixed size of the ROI.

In another example, if a single bounding box is provided to the DL system 926, as shown in the example cropped frame 925 of FIG. 9, a fixed-size ROI can be generated so that the bounding box is centered in the ROI.

In other implementations, a maximum size ROI can be defined, and the DL system 926 can generate ROIs having different sizes based on the size and/or amount of bounding boxes generated for a given video frame. The maximum size ROI can set a high limit on the duration needed to perform the DL-1 process, so that the DL-1 process can finish every P video frames as a maximum duration.

In some implementations, only a single ROI can be generated by the DL-1 process for each video frame, further allowing the video analytics system 600 to set a pre-defined duration for the DL-1 process to process a video frame. In some implementations, multiple ROIs can be generated for each video frame. For example, if objects are detected that are too far apart to be covered by a single ROI (e.g., a fixed size ROI, a maximum size ROI, or the like), one or more other ROIs can be generated to cover all of the detected objects. In some cases, a single instance or thread of the ROI generation process can be performed to generate multiple ROIs, which can extend the amount of time needed to perform the DL-1 process. In some cases, a separate instance or thread of the ROI generation process can be performed for each ROI that is generated for a given frame, in which case a number of resources needed for each instance or thread is proportional to the number of ROIs that will be generated (e.g., if two ROIs are generated, two threads of the ROI generation process can be run in parallel).

The DL system 926 can perform ROI clipping 927 using the generated ROIs. ROI clipping 927 includes cropping the one or more ROIs from the video frame 914 to generate a cropped video frame (which can also be referred to as a cropped image). A cropped video frame is illustrated as a bolded bounding box within the frame 925 shown in FIG. 9. The cropped video frame includes only the portion of the video frame corresponding to an ROI. In some implementations, if more than one ROI is generated for a video frame, a separate cropped image can be generated for each ROI, resulting in multiple cropped images (or cropped video frames) being generated from the full-sized video frame. Once a cropped video frame is generated, it can then be provided to a deep learning network engine (e.g., deep learning network engine 726 or forensic deep learning network engine 727) for application of a trained neural network (e.g., a deep learning network). Using a cropped portion of the higher resolution video frame 914 (instead of the entire video frame 914) that includes one or more objects of interest reduces the processing time and complexity of the deep network needed to process the video frame. As noted previously, using cropped frames reduces and can even eliminate the problem of classifying small objects. An object in the cropped image is large relative to the frame height, allowing the deep learning network engine to more accurately classify the object, as illustrated in the chart shown in FIG. 5.

The deep learning network engine 726 applies a deep learning network to the cropped video frame to determine classes for the one or more objects in the cropped frame. If one or more classes are determined for the one or more objects in the cropped frame, the deep learning network engine can output class information 928 for the objects to a storage device (not shown) that maintains metadata 929 for objects classified for the current video frame (corresponding to frames 914 and 916). The class information 928 is used to update the metadata 929 for the objects that have been classified. In some cases, the deep network can also identify the location of one or more of the objects, in which case the metadata 929 is also updated to include the localization information. For example, as noted above, each of the bounding boxes is associated with a tracker ID. Each bounding box that is within a ROI generated by the DL system 926 is monitored to determine if a class (and/or a location) has been determined for the object associated with the bounding box. If a class (and/or a location) is determined for an object associated with a bounding box, the metadata 929 can be updated to indicate that the object has been classified (and/or a localized) by the DL system 926.

In some cases, the metadata 929 can be checked when a current frame is being processed to determine whether one or more bounding boxes generated for the frame are associated with objects that have been previously classified. In some implementations, during future iterations of the DL-1 process (e.g., P-frames after the current frame), bounding boxes associated with previously-classified objects can be disregarded when determining ROIs, in which case the objects are not re-classified. In such cases, only bounding boxes that are associated with objects that have not been classified will be considered by the DL system 926 when generating ROIs.

In some cases, the deep learning network applied by the deep learning network engine 726 can provide confidence levels when classifying an object. For example, as described in more detail below, a deep learning network can generate a probability vector (or other representation of a set of probabilities) that includes probabilities indicating that an object is a certain class of object (e.g., a person, a dog, a car, or other suitable class), with a probability for each class being included in the vector. A probability that an object is a certain class can be used as a confidence level that the object is part of the class. A threshold confidence level can be defined, which sets a minimum confidence level for considering an object as being classified. In one illustrative example, the threshold can be set to 0.6, indicating that an object must have a probability for a class of at least 60% to be considered as being a part of that class. When a current video frame is being processed by the DL system 926, the metadata 929 for the tracked objects associated with the bounding boxes provided for the frame can be checked to determine if a confidence level for an object exceeds (or is equal to in some cases) the threshold. If the confidence level exceeds the threshold, the bounding box for that object can be disregarded. However, if the confidence level does not exceed the threshold, the bounding box can be considered when generating ROIs for the current video frame. In such cases, the DL-1 process can run the deep learning network on the object again in an attempt to re-classify the object with a higher confidence level.

As noted above with respect to FIG. 8, the DL-1 process can continue to be applied until the object life 808 of an object comes to an end. An object's life is considered to come to an end when a blob representing the object is no longer detected and/or tracked in the video sequence by the object detection and tracking systems. For instance, the life of an object that is given a lost status in a current video frame can be considered as ended as of that video frame. For example, a blob representing the object may be detected and tracked in one frame, but may no longer be detected in the next video frame, in which case the blob (and object) is given a lost status. The object's life can then be considered as ended at the next video frame. In one illustrative example, a person being tracked may leave the scene being captured in the video sequence, after which a blob for the person will no longer be detected. In another illustrative example, a person being tracked may become still or static (not moving), in which case pixels for the object may be detected as background by the blob detection system. In such an example, a blob will not be detected for the object after a certain period of time after the object becomes still. In some cases, the object can be given a dead status after the blob representing the object is lost for a certain duration. The lost (or dead) status of the object can be kept in the object metadata associated with the object.

An object's status can be checked at each frame by analyzing the object metadata for that object. When an object's life is determined to be ended, the forensic deep learning network engine 727 can perform a deep learning forensic process (e.g., DL-2 Forensics process 812), which includes applying a second deep learning network to a ROI containing the object. In such examples, the ROI including that object can be provided to the forensic deep learning network engine 727 instead of the deep learning network engine 726. In some cases, when multiple objects are included within an ROI, and a first object is not lost and a second object is lost, the ROI can be provided to both the deep learning network engine 726 and the forensic deep learning network engine 727. The deep learning network engine 726 can attempt to classify the first object using the DL-1 process and the forensic deep learning network engine 727 can attempt to classify the second object using the DL-2 Forensic process 812.

A periodic report (e.g., hourly, daily, weekly, monthly, or other suitable period) can be saved and maintained by the video analytics system 600. A benefit of classifying an object using the DL-2 Forensic process 812 after the life of the object has ended includes updating such a report with a classification of the object. In some cases, a user of the video analytics system (e.g., a company, a home user, or other user of the video analytics system) can use the report to identify events that have occurred over a period of time. In one illustrative example, a guard of a company parking lot might need to review a report to identify what has happened while the guard was away for a period of time. Being able to detect and classify as many objects in a scene, saving the classified objects in metadata for the objects, and generating events based on the classified objects is important for video analytics systems. The ability of the video analytics system 600 to detect and classify objects in real-time is a great enhancement over current video analytics solutions, and further being able to classify objects using the DL-2 process performed by the forensic deep learning network engine 727 even when the real-time DL-1 process performed by the deep learning network engine 726 fails provides an even greater benefit to video analytics solutions.

The second deep learning network applied by the DL-2 Forensics process 812 includes a more complex network than the deep learning network applied by the DL-1 process. In some cases, the deep learning network of the real-time DL-1 process can apply a subset training set of the training set used by the DL-2 Forensic process 812. In some cases, the deep learning network used by the DL-2 Forensic process 812 can use a larger network with more layers than the network of the DL-1 process. For instance, the second deep learning network applied by the DL-2 Forensics process 812 can include more hidden layers than the deep learning network applied by the DL-1 process. The additional hidden layers allow the deep learning network of the DL-2 Forensics process 812 to determine more features of an object than the deep network of the DL-1 process can determine, leading to a more accurate classification of the object. The DL-2 Forensics process 812 is more complex, and thus will take longer to process image data than the DL-1 process. Because of the additional complexity, the DL-2 Forensics process 812 can be applied to classify an object after the object's life is ended, instead of being performed on a periodic basis.

FIG. 10 is a diagram illustrating the DL-2 Forensics process 1012. At step 1020, the DL-2 Forensics process 1012 determines whether an object's life is terminated or ended at a current video frame. For example, at each video frame, the object's metadata can be checked to determine whether the object has a lost or dead status. If the object's life is determined to not be terminated, the DL-2 Forensics process 1012 can terminate, in which case the DL-1 process can be performed if the current frame satisfies the period N. If the object's life is determined to be terminated (e.g., the object has a lost or dead state), the DL-2 Forensics process 1012 continues to step 1022.

At step 1022, the DL-2 Forensics process 1012 determines whether the object has been classified. In the event the object has been classified, the DL-2 Forensics process 1012 is terminated and the DL-1 process can be performed if the current frame satisfies the period P. In some cases, step 1022 also includes determining if a previous classification for the object includes a confidence level that is below or above a threshold confidence level, as described above. If the confidence level that the object is of a certain class is above the threshold confidence level (or equal to in some cases), the DL-2 Forensics process 1012 can be terminated and the DL-1 process can be performed if the current frame satisfies the period P. If the object is determined to not have been previously classified (or the confidence level is below or equal to the threshold confidence level), the DL-2 Forensics process 1012 continues to step 1024.

In some examples, a ROI (or cropped image associated with the ROI) determined during the ROI clipping 927 process can be queued for use by the DL-2 Forensics process 1012. In some cases, a frame including the ROI can be queued instead of the ROI or cropped image associated with the ROI. Each ROI generated by the ROI clipping 927 process for a given object can be analyzed to determine which ROI (or frame) for the given object will be queued for the DL-2 Forensics process 1012. For example, the first ROI that is generated for an object can be queued. If another ROI is generated for the object (based on the bounding box associated with that object) in a subsequent frame, a characteristic of the cropped image associated with the ROI in the subsequent frame can be compared to a cropped image associated with the currently queued ROI for the object. The ROI, cropped image, or frame with the best image qualities for the object can be kept in the queue. For instance, if the ROI from the subsequent frame has better image qualities than the cropped image of the currently queued ROI, the currently queued ROI can be replaced with the ROI from the subsequent frame. The quality of a cropped image for an object can include a sharpness of the object in the cropped image, a size of the object in the cropped image relative to the height (or width) of the image, or any other measure of quality that can increase the success rate of the DL-2 Forensic process 1012. In some examples, the system can queue the ROI (or cropped image) or frame with the highest score (or confidence level) for an object that has not yet exceeded the threshold described above (in which case the object has not yet been considered as being classified).

At step 1024, the DL-2 Forensics process 1012 applies the second deep learning network (denoted as forensic deep learning network in FIG. 10) to a cropped video frame (e.g., according to the currently queued ROI for the object) in an attempt to classify the object. At step 1026, the DL-2 Forensics process 1012 determines whether the object has been classified using the second deep learning network. If the object has been classified, the metadata 1029 for the object is updated to include the class. In some cases, the metadata 1029 can also be updated to include an indication that the object has been classified. In the event the object is not classified by the second deep learning network, the DL-2 Forensics process 1012 may be applied again for a future frame, or it may be determined that the object cannot be classified.

The deep learning networks applied by the deep learning network engine 726 and the forensic deep learning network engine 727 can include any suitable deep network, such as a convolutional neural network (CNN), an autoencoder, a deep belief net (DBN), a Recurrent Neural Networks (RNN), or any other suitable deep network. FIG. 11 is an illustrative example of a deep learning network 1100. An input layer 1120 includes input data. In one illustrative example, the input layer 1120 can include data representing the pixels of an input video frame. The deep learning network 1100 includes multiple hidden layers 1122a, 1122b, through 1122n. The hidden layers 1122a, 1122b, through 1122n include “n” number of hidden layers, where “n” is an integer greater than or equal to one. The number of hidden layers can be made to include as many layers as needed for the given application. The deep learning network 1100 further includes an output layer 1124 that provides an output resulting from the processing performed by the hidden layers 1122a, 1122b, through 1122n. In one illustrative example, the output layer 1124 can provide a classification and/or a localization for an object in an input video frame. The classification can include a class identifying the type of object (e.g., a person, a dog, a cat, or other object) and the localization can include a bounding box indicating the location of the object.

The deep learning network 1100 is a multi-layer neural network of interconnected nodes. Each node can represent a piece of information. Information associated with the nodes is shared among the different layers and each layer retains information as information is processed. In some cases, the deep learning network 1100 can include a feed-forward network, in which case there are no feedback connections where outputs of the network are fed back into itself In some cases, the network 1100 can include a recurrent neural network, which can have loops that allow information to be carried across nodes while reading in input.

Information can be exchanged between nodes through node-to-node interconnections between the various layers. Nodes of the input layer 1120 can activate a set of nodes in the first hidden layer 1122a. For example, as shown, each of the input nodes of the input layer 1120 is connected to each of the nodes of the first hidden layer 1122a. The nodes of the hidden layer 1122 can transform the information of each input node by applying activation functions to these information. The information derived from the transformation can then be passed to and can activate the nodes of the next hidden layer 1122b, which can perform their own designated functions. Example functions include convolutional, up-sampling, data transformation, and/or any other suitable functions. The output of the hidden layer 1122b can then activate nodes of the next hidden layer, and so on. The output of the last hidden layer 1122n can activate one or more nodes of the output layer 1124, at which an output is provided. In some cases, while nodes (e.g., node 1126) in the deep learning network 1100 are shown as having multiple output lines, a node has a single output and all lines shown as being output from a node represent the same output value.

In some cases, each node or interconnection between nodes can have a weight that is a set of parameters derived from the training of the deep learning network 1100. For example, an interconnection between nodes can represent a piece of information learned about the interconnected nodes. The interconnection can have a tunable numeric weight that can be tuned (e.g., based on a training dataset), allowing the deep learning network 1100 to be adaptive to inputs and able to learn as more and more data is processed.

The deep learning network 1100 is pre-trained to process the features from the data in the input layer 1120 using the different hidden layers 1122a, 1122b, through 1122n in order to provide the output through the output layer 1124. In an example in which the deep learning network 1100 is used to identify objects in images, the network 1100 can be trained using training data that includes both images and labels. For instance, training images can be input into the network, with each training image having a label indicating the classes of the one or more objects in each image (basically, indicating to the network what the objects are and what features they have). In one illustrative example, a training image can include an image of a number 2, in which case the label for the image can be [0 0 1 0 0 0 0 0 0 0].

In some cases, the deep neural network 1100 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the network 1100 is trained well enough so that the weights of the layers are accurately tuned.

For the example of identifying objects in images, the forward pass can include passing a training image through the network 1100. The weights are initially randomized before the deep neural network 1100 is trained. The image can include, for example, an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

For a first training iteration for the network 1100, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the network 1100 is unable to determine low level features and thus cannot make an accurate determination of what the classification of the object might be. A loss function can be used to analyze error in the output. Any suitable loss function definition can be used. One example of a loss function includes a mean squared error (MSE). The MSE is defined as

$${E}_{total} = Σ \frac{1}{2} {( target - output )}^{2} ,$$

which calculates the sum of one-half times the actual answer minus the predicted (output) answer squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The deep learning network 1100 can perform a backward pass by determining which inputs (weights) most contributed to the loss of the network, and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{dL}{dW} ,$$

where w denotes a weight, wᵢ denotes the initial weight, and η denotes a learning rate. The learning rate can be set to any suitable value, with a high learning rate including larger weight updates and a lower value indicating smaller weight updates.

The deep learning network 1100 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. The deep learning network 1100 can include any other deep network other than a CNN, such as an autoencoder, a deep belief nets (DBNs), a Recurrent Neural Networks (RNNs), among others.

FIG. 12 is an illustrative example of a convolutional neural network 1200 (CNN 1200). The input layer 1220 of the CNN 1200 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1222a, an optional non-linear activation layer, a pooling hidden layer 1222b, and fully connected hidden layers 1222c to get an output at the output layer 1224. While only one of each hidden layer is shown in FIG. 12, one of ordinary skill will appreciate that multiple convolutional hidden layers, non-linear layers, pooling hidden layers, and/or fully connected layers can be included in the CNN 1200. As previously described, the output can indicate a single class of an object or can include a probability of classes that best describe the object in the image.

The first layer of the CNN 1200 is the convolutional hidden layer 1222a. The convolutional hidden layer 1222a analyzes the image data of the input layer 1220. Each node of the convolutional hidden layer 1222a is connected to a region of nodes (pixels) of the input image called a receptive field. The convolutional hidden layer 1222a can be considered as one or more filters (each filter corresponding to a different activation or feature map), with each convolutional iteration of a filter being a node or neuron of the convolutional hidden layer 1222a. For example, the region of the input image that a filter covers at each convolutional iteration would be the receptive field for the filter. In one illustrative example, if the input image includes a 28×28 array, and each filter (and corresponding receptive field) is a 5 ×5 array, then there will be 24×24 nodes in the convolutional hidden layer 1222a. Each connection between a node and a receptive field for that node learns a weight and, in some cases, an overall bias such that each node learns to analyze its particular local receptive field in the input image. Each node of the hidden layer 1222a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 1222a is due to each node of the convolutional layer being applied to its corresponding receptive field. For example, a filter of the convolutional hidden layer 1222a can begin in the top-left corner of the input image array and can convolve around the input image. As noted above, each convolutional iteration of the filter can be considered a node or neuron of the convolutional hidden layer 1222a. At each convolutional iteration, the values of the filter are multiplied with a corresponding number of the original pixel values of the image (e.g., the 5×5 filter array is multipled by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1222a. For example, a filter can be moved by a step amount to the next receptive field. The step amount can be set to 1 or other suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1222a.

The mapping from the input layer to the convolutional hidden layer 1222a is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 1222a can include several activation maps in order to identify multiple features in an image. The example shown in FIG. 12 includes three activation maps. Using three activation maps, the convolutional hidden layer 1222a can detect three different kinds of features, with each feature being detectable across the entire image.

In some examples, a non-linear hidden layer can be applied after the convolutional hidden layer 1222a. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the network 1200 without affecting the receptive fields of the convolutional hidden layer 1222a.

The pooling hidden layer 1222b can be applied after the convolutional hidden layer 1222a (and after the non-linear hidden layer when used). The pooling hidden layer 1222b is used to simplify the information in the output from the convolutional hidden layer 1222a. For example, the pooling hidden layer 1222b can take each activation map output from the convolutional hidden layer 1222a and generates a condensed activation map (or feature map) using a pooling function. Max-pooling is one example of a function performed by a pooling hidden layer. Other forms of pooling functions be used by the pooling hidden layer 1222a, such as average pooling, L2-norm pooling, or other suitable pooling functions. A pooling function (e.g., a max-pooling filter, an L2-norm filter, or other suitable pooling filter) is applied to each activation map included in the convolutional hidden layer 1222a. In the example shown in FIG. 12, three pooling filters are used for the three activation maps in the convolutional hidden layer 1222a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 1222a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1222a having a dimension of 24×24 nodes, the output from the pooling hidden layer 1222b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling), and using the computed values as an output.

Intuitively, the pooling function (e.g., max-pooling, L2-norm pooling, or other pooling function) determines whether a given feature is found anywhere in a region of the image, and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1200.

The final layer of connections in the network is a fully-connected layer that connects every node from the pooling hidden layer 1222b to every one of the output nodes in the output layer 1224. Using the example above, the input layer includes 28×28 nodes encoding the pixel intensities of the input image, the convolutional hidden layer 1222a includes 3×24×24 hidden feature nodes based on application of a 5×5 local receptive field (for the filters) to three activation maps, and the pooling layer 1222b includes a layer of 3×12×12 hidden feature nodes based on application of max-pooling filter to 2×2 regions across each of the three feature maps. Extending this example, the output layer 1224 can include ten output nodes. In such an example, every node of the 3×12×12 pooling hidden layer 1222b is connected to every node of the output layer 1224.

The fully connected layer 1222c can obtain the output of the previous pooling layer 1222b (which should represent the activation maps of high-level features) and determines the features that most correlate to a particular class. For example, the fully connected layer 1222c layer can determine the high-level features that most strongly correlate to a particular class, and can include weights (nodes) for the high-level features. A product can be computed between the weights of the fully connected layer 1222c and the pooling hidden layer 1222b to obtain probabilities for the different classes. For example, if the CNN 1200 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1224 can include an M-dimensional vector (in the prior example, M=10), where M can include the number of classes that the program has to choose from when classifying the object in the image. Other example outputs can also be provided. Each number in the N-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

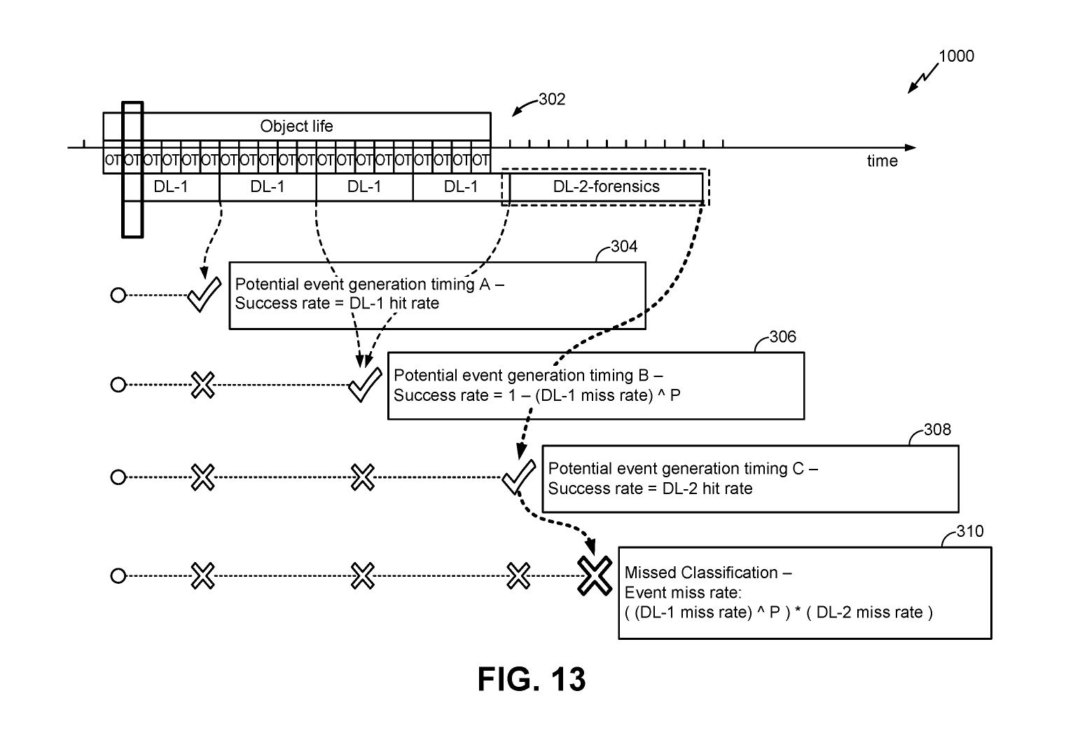

FIG. 13 is a diagram illustrating an example of real-time event hit-rate enhancement provided by the object detection process using object tracking and deep learning, as described above. An event generation can include successful classification of an object (as illustrated by a checkmark in FIG. 13). As shown, at the end of the first iteration of the DL-1 process, the fastest event generation time includes a success rate equal to the processing time needed by the deep learning system to perform the DL-1 process for a single frame (shown as Potential event generation time A). The processing time can be equal to the period P described above. At each iteration, the total timing is increased by a factor of the period P at which the DL-1 process is performed, and is based on the number of times the DL-1 process has been performed for the object (with each iteration of DL-1 being performed at every P number of frames). The success rate of each iteration is shown in FIG. 13 as Potential event generation timing B being equal to 1−(DL-1 miss rate)\hat{0}P.

In the event the DL-2 Forensic process is performed, the success rate for the DL-2 Forensic process is equal to the DL-2 hit rate (shown as Potential event generation time C). The latest event generation time for a successful classification of an object thus includes the object's life plus the DL-1 process processing time (as a factor of P) for the object plus the DL-2 forensic process processing time for the object.

If the DL-2 Forensic process is performed, but is unsuccessful in classifying an object, the event miss rate is shown in FIG. 13 as being equal to ((DL-1 miss rate) \hat{0} P)*(DL-2 miss rate).

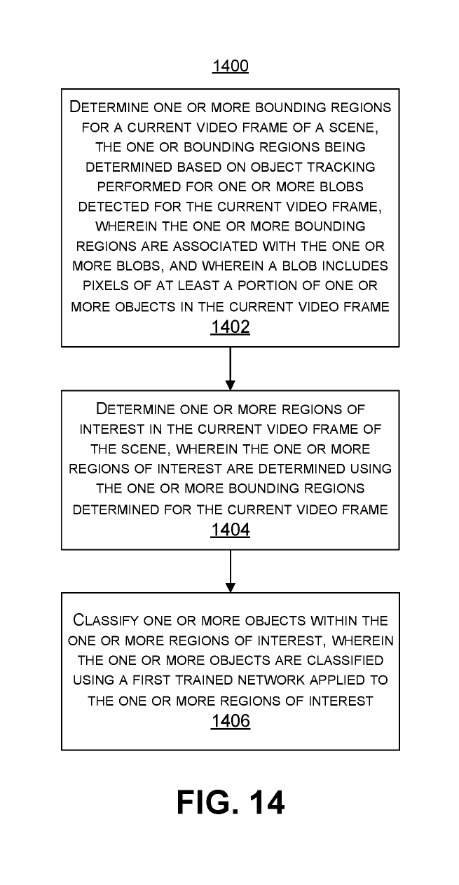

FIG. 14 is a flowchart illustrating an example of a process 1400 of classifying objects in one or more video frames provided using the techniques described herein. At block 1402, the process 1400 includes determining one or more bounding boxes for a current video frame of a scene. The one or bounding boxes are determined based on object tracking performed for one or more blobs detected for the current video frame. For example, the one or more blobs can be detected by the blob detection system 604 and the object tracking can be performed by the object tracking system 606 to track the one or more blobs, using the techniques described herein. The one or more bounding boxes are associated with the one or more blobs. For example, a bounding box from the one or more bounding boxes can be assigned to an object tracker and can be used to track a blob from the one or more blobs. A blob includes pixels of at least a portion of one or more objects in the current video frame.

At block 1404, the process 1400 includes determining one or more regions of interest in the current video frame of the scene. The one or more regions of interest are determined using the one or more bounding boxes determined for the current video frame.

At block 1406, the process 1400 includes classifying one or more objects within the one or more regions of interest. The one or more objects are classified using a first deep learning classification network applied to the one or more regions of interest. For example, the first deep learning network can be applied using the DL-1 process performed by the deep learning network engine 726 described above. In some examples, the first deep learning classification network is not applied to regions of the current video frame that are outside of the one or more regions of interest. In some examples, the one or more regions of interest encompass the one or more bounding boxes determined for the first video frame. For example, the ROI determination engine 722 can generate a region of interest to encompass at least one bounding box. In some cases, a region of interest can be generated to encompass multiple bounding boxes based on the size of the region of interest.

In some examples, the one or more objects within the one or more regions of interest are classified in real-time using the first deep learning classification network as a video sequence comprising the current video frame is received. In some examples, object tracking results from one or more video frames of a video sequence are periodically used by the first deep learning classification network to classify one or more objects in the one or more video frames. For example, as shown in FIG. 8 and FIG. 9, the object detection and tracking can be performed for every video frame of a video sequence, and the DL-1 process can be applied every P frames (as shown by a first iteration 806 of the DL-1 process).

In some examples, the process 1400 includes updating a status of the one or more objects. The status indicates the one or more blobs representing the one or more objects have been classified. For example, metadata maintained for an object can include the status of an object. The metadata can be updated to indicate the object has been classified in the event the first deep learning network (or the second deep learning network described below) is successful in classifying the object.

In some examples, the object tracking is performed on a first version of the current video frame to determine the one or more bounding boxes, and the first deep learning classification network is applied to a cropped portion of a second version of the current video frame. The cropped portion of the second version of the current video frame corresponds to the one or more regions of interest. For example, a region of interest can be cropped from the entire current video frame, leaving only the region of interest to be analyzed by the first (or second) deep learning network.

In some examples, the first version of the current video frame has a first resolution and the second version of the current video frame has a second resolution. The first resolution is a lower resolution than the second resolution. For example, the first version can include a 1080 p resolution frame, and the second version can include a 4K resolution frame. In some implementations, the first version of the current video frame is a downsampled version of the second version of the current video frame. Using the previous example, the 4K resolution frame (used for application of the deep learning classification network) can be downsampled to obtain the 1080 p resolution frame (used for object detection and tracking). In some implementations, the first version of the current video frame and the second version of the current video frame include different video frames having different resolutions, in which case the first version of the current video frame and the second version of the current video frame capture the scene at a same time instance, and thus capture the same image of the scene.

In some examples, the process 1400 includes determining an object was not classified by a previous iteration of the first deep learning classification network in a previous video frame. For example, the object can be determined not to have been classified based on the metadata maintained for the object. The process 1400 can further include determining, based on the object not being classified by the previous iteration of the first deep learning classification network, a region of interest containing the object in the current video frame. The region of interest is determined using a bounding box associated with a blob representing the object. For example, the ROI determination engine 722 can generate the region of interest to encompass the bounding box. The process 1400 can further include applying the first deep learning classification network to the region of interest. In some implementations, the current video frame is a first video frame after completion of the previous iteration of the first deep learning classification network (e.g., at a next period P).

In some examples, the process 1400 includes determining an object was classified by a previous iteration of the first deep learning classification network in a previous video frame. For example, the object can be determined not to have been classified based on the metadata maintained for the object. The process 1400 can further include determining not to apply the first deep learning classification network on the object based on the object being classified by the previous iteration of the first deep learning classification network.

In some examples, the process 1400 includes determining a classification confidence score determined for an object using a previous iteration of the first deep learning classification network in a previous video frame. For example, the classification confidence score for the object can be determined based on the metadata maintained for the object. The process 1400 can further include determining the classification confidence score for the object is below a threshold score, and determining, based on the classification confidence score being below the threshold score, a region of interest containing the object in the current video frame. The region of interest is determined using a bounding box determined for a blob representing the object. For example, the ROI determination engine 722 can generate the region of interest to encompass the bounding box. The process 1400 can further include applying the first deep learning classification network to the region of interest. In some aspects, the current video frame is a first video frame after completion of the previous iteration of the first deep learning classification network (e.g., at a next period P).

In some examples, the process 1400 includes determining a blob detected in one or more previous video frames is no longer detected in the current frame. The blob is associated with an object in the scene. For example, the life of the object (and/or blob) can be determined to be over. The process 1400 can further include determining the object was not classified by the first deep learning classification network in the one or more previous video frames. For example, the object can be determined not to have been classified based on the metadata maintained for the object. The process 1400 can further include identifying a region of interest of a previous video frame containing the object. For example, the region of interest of the previous video frame includes a queued region of interest. As previously described, the region of interest can be selected to be the queued region of interest from among regions of interest determined for the one or more previous frames. For instance, the region of interest can be selected to be the queued region of interest from among the regions of interest determined for the one or more previous frames based on one or more factors associated with the region of interest. The one or more factors associated with the region of interest can include at least one of a sharpness of the object in the region of interest or a size of the object in the region of interest. The process 1400 can further include classifying the object contained within the region of interest, in which case the object is classified using a second deep learning classification network applied to the region of interest. The second deep learning classification network has more hidden layers than the first deep learning classification network. The second deep learning classification network can include the forensics deep network of the DL-2 Forensics process 812 applied by the forensic deep learning network engine 727 described above. In some cases, the first deep learning classification network is performed for the object until the blob associated with the object is no longer detected (the object's life is over).

In some examples, the process 1400 may be performed by a computing device or an apparatus, such as the video analytics system 100. In one illustrative example, the process 1400 can be performed by the video analytics system 600 shown in FIG. 6. In some cases, the computing device or apparatus may include a processor, microprocessor, microcomputer, or other component of a device that is configured to carry out the steps of process 1400. In some examples, the computing device or apparatus may include a camera configured to capture video data (e.g., a video sequence) including video frames. For example, the computing device may include a camera device (e.g., an IP camera or other type of camera device) that may include a video codec. In some examples, a camera or other capture device that captures the video data is separate from the computing device, in which case the computing device receives the captured video data. The computing device may further include a network interface configured to communicate the video data. The network interface may be configured to communicate Internet Protocol (IP) based data.

Process 1400 is illustrated as logical flow diagrams, the operation of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1400 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

The object detection systems and methods described herein combine the strengths of both object detection/tracking (OT) and deep learning (DL) to accurately classify objects in real-time. Table 1 below illustrates the benefits of such an object classification system.

TABLE 1

Engine
capacity

| | OT | DL |
|---|---|---|
| Small object detection | V | |
| High frame rate | V | |
| Tracking capability | V | |
| Meaningful object info | | V |
| Ungrouping clustering objects | | V |
| Dynamic background | | V |
| adjustment | | |
| Little-motion or still object | | V |
| detection | | |

The video analytics operations discussed herein may be implemented using compressed video or using uncompressed video frames (before or after compression). An example video encoding and decoding system includes a source device that provides encoded video data to be decoded at a later time by a destination device. In particular, the source device provides the video data to destination device via a computer-readable medium. The source device and the destination device may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, the source device and the destination device may be equipped for wireless communication.

The destination device may receive the encoded video data to be decoded via the computer-readable medium. The computer-readable medium may comprise any type of medium or device capable of moving the encoded video data from source device to destination device. In one example, computer-readable medium may comprise a communication medium to enable source device to transmit encoded video data directly to destination device in real-time. The encoded video data may be modulated according to a communication standard, such as a wireless communication protocol, and transmitted to destination device. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device to destination device.

In some examples, encoded data may be output from output interface to a storage device. Similarly, encoded data may be accessed from the storage device by input interface. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device may correspond to a file server or another intermediate storage device that may store the encoded video generated by source device. Destination device may access stored video data from the storage device via streaming or download. The file server may be any type of server capable of storing encoded video data and transmitting that encoded video data to the destination device. Example file servers include a web server (e.g., for a website), an FTP server, network attached storage (NAS) devices, or a local disk drive. Destination device may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof.

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system may be configured to support one-way or two-way video transmission to support applications such as video streaming, video playback, video broadcasting, and/or video telephony.

In one example the source device includes a video source, a video encoder, and a output interface. The destination device may include an input interface, a video decoder, and a display device. The video encoder of source device may be configured to apply the techniques disclosed herein. In other examples, a source device and a destination device may include other components or arrangements. For example, the source device may receive video data from an external video source, such as an external camera. Likewise, the destination device may interface with an external display device, rather than including an integrated display device.

The example system above merely one example. Techniques for processing video data in parallel may be performed by any digital video encoding and/or decoding device. Although generally the techniques of this disclosure are performed by a video encoding device, the techniques may also be performed by a video encoder/decoder, typically referred to as a “CODEC.” Moreover, the techniques of this disclosure may also be performed by a video preprocessor. Source device and destination device are merely examples of such coding devices in which source device generates coded video data for transmission to destination device. In some examples, the source and destination devices may operate in a substantially symmetrical manner such that each of the devices include video encoding and decoding components. Hence, example systems may support one-way or two-way video transmission between video devices, e.g., for video streaming, video playback, video broadcasting, or video telephony.

The video source may include a video capture device, such as a video camera, a video archive containing previously captured video, and/or a video feed interface to receive video from a video content provider. As a further alternative, the video source may generate computer graphics-based data as the source video, or a combination of live video, archived video, and computer-generated video. In some cases, if video source is a video camera, source device and destination device may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by the video encoder. The encoded video information may then be output by output interface onto the computer-readable medium.

As noted, the computer-readable medium may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from the source device and provide the encoded video data to the destination device, e.g., via network transmission. Similarly, a computing device of a medium production facility, such as a disc stamping facility, may receive encoded video data from the source device and produce a disc containing the encoded video data. Therefore, the computer-readable medium may be understood to include one or more computer-readable media of various forms, in various examples.

One of ordinary skill will appreciate that the less than (“<”) and greater than (“>”) symbols or terminology used herein can be replaced with less than or equal to (“≤”) and greater than or equal to (”≥“) symbols, respectively, without departing from the scope of this description.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

What is claimed is:

1. A method of classifying objects in one or more video frames, the method comprising:
determining one or more bounding regions for a current video frame of a scene, the one or bounding regions being determined based on object tracking performed for one or more blobs detected for the current video frame, wherein the one or more bounding regions are associated with the one or more blobs, and wherein a blob includes pixels of at least a portion of one or more objects in the current video frame;
determining one or more regions of interest in the current video frame of the scene, wherein the one or more regions of interest are determined using the one or more bounding regions determined for the current video frame; and
classifying one or more objects within the one or more regions of interest, wherein the one or more objects are classified using a first trained network applied to the one or more regions of interest.

2. The method of claim 1, wherein the first trained network is not applied to regions of the current video frame that are outside of the one or more regions of interest.

3. The method of claim 1, wherein the one or more regions of interest encompass the one or more bounding regions determined for the first video frame.

4. The method of claim 1, wherein the one or more objects within the one or more regions of interest are classified in real-time using the first trained network as a video sequence comprising the current video frame is received.

5. The method of claim 1, further comprising updating a status of the one or more objects, the status indicating the one or more blobs representing the one or more objects have been classified.

6. The method of claim 1, wherein the object tracking is performed on a first version of the current video frame to determine the one or more bounding regions, and wherein the first trained network is applied to a cropped portion of a second version of the current video frame, the cropped portion corresponding to the one or more regions of interest.

7. The method of claim 6, wherein the first version of the current video frame has a first resolution and the second version of the current video frame has a second resolution, the first resolution being a lower resolution than the second resolution.

8. The method of claim 6, wherein the first version of the current video frame is a downsampled version of the second version of the current video frame.

9. The method of claim 6, wherein the first version of the current video frame and the second version of the current video frame include different video frames having different resolutions, and wherein the first version of the current video frame and the second version of the current video frame capture the scene at a same time instance.

10. The method of claim 1, wherein object tracking results from one or more video frames of a video sequence are periodically used by the first trained network to classify one or more objects in the one or more video frames.

11. The method of claim 1, further comprising:
determining an object was not classified by a previous iteration of the first trained network in a previous video frame;
determining, based on the object not being classified by the previous iteration of the first trained network, a region of interest containing the object in the current video frame, the region of interest being determined using a bounding region associated with a blob representing the object; and
applying the first trained network to the region of interest in the current video frame.

12. The method of claim 11, wherein the current video frame is a first video frame after completion of the previous iteration of the first trained network.

13. The method of claim 1, further comprising:
determining an object was classified by a previous iteration of the first trained network in a previous video frame; and
determining not to apply the first trained network on the object based on the object being classified by the previous iteration of the first trained network.

14. The method of claim 1, further comprising:
determining a classification confidence score determined for an object using a previous iteration of the first trained network in a previous video frame;
determining the classification confidence score for the object is below a threshold score;
determining, based on the classification confidence score being below the threshold score, a region of interest containing the object in the current video frame, the region of interest being determined using a bounding region determined for a blob representing the object; and
applying the first trained network to the region of interest in the current video frame.

15. The method of claim 14, wherein the current video frame is a first video frame after completion of the previous iteration of the first trained network.

16. The method of claim 1, further comprising:
determining a blob detected in one or more previous video frames is no longer detected in the current frame, the blob being associated with an object in the scene;
determining the object was not classified by the first trained network in the one or more previous video frames;
identifying a region of interest of a previous video frame containing the object; and
classifying the object contained within the region of interest, wherein the object is classified using a second trained network applied to the region of interest, the second trained network having more hidden layers than the first trained network.

17. The method of claim 16, wherein the first trained network is performed for the object until the blob associated with the object is no longer detected.

18. The method of claim 16, wherein the region of interest includes a queued region of interest, wherein the region of interest is selected to be the queued region of interest from among regions of interest determined for the one or more previous frames.

19. The method of claim 18, wherein the region of interest is selected to be the queued region of interest from among the regions of interest determined for the one or more previous frames based on one or more factors associated with the region of interest.

20. The method of claim 19, wherein the one or more factors associated with the region of interest include at least one of a sharpness of the object in the region of interest or a size of the object in the region of interest.

21. An apparatus for classifying objects in one or more video frames, comprising:
a memory configured to store video data associated with the video frames; and
a processor configured to:
determine one or more bounding regions for a current video frame of a scene, the one or bounding regions being determined based on object tracking performed for one or more blobs detected for the current video frame, wherein the one or more bounding regions are associated with the one or more blobs, and wherein a blob includes pixels of at least a portion of one or more objects in the current video frame;
determine one or more regions of interest in the current video frame of the scene, wherein the one or more regions of interest are determined using the one or more bounding regions determined for the current video frame; and
classify one or more objects within the one or more regions of interest, wherein the one or more objects are classified using a first trained network applied to the one or more regions of interest.

22. The apparatus of claim 21, wherein the first trained network is not applied to regions of the current video frame that are outside of the one or more regions of interest.

23. The apparatus of claim 21, wherein the object tracking is performed on a first version of the current video frame to determine the one or more bounding regions, and wherein the first trained network is applied to a cropped portion of a second version of the current video frame, the cropped portion corresponding to the one or more regions of interest.

24. The apparatus of claim 21, wherein object tracking results from one or more video frames of a video sequence are periodically used by the first trained network to classify one or more objects in the one or more video frames.

25. The apparatus of claim 21, wherein the processor is configured to:
determine an object was not classified by a previous iteration of the first trained network in a previous video frame;
determine, based on the object not being classified by the previous iteration of the first trained network, a region of interest containing the object in the current video frame, the region of interest being determined using a bounding region associated with a blob representing the object; and
apply the first trained network to the region of interest in the current video frame.

26. The apparatus of claim 21, wherein the processor is configured to:
determine an object was classified by a previous iteration of the first trained network in a previous video frame; and
determine not to apply the first deep learning classification network on the object based on the object being classified by the previous iteration of the first deep learning classification network.

27. The apparatus of claim 21, wherein the processor is configured to:
determine a classification confidence score determined for an object using a previous iteration of the first deep learning classification network in a previous video frame;
determine the classification confidence score for the object is below a threshold score;
determine, based on the classification confidence score being below the threshold score, a region of interest containing the object in the current video frame, the region of interest being determined using a bounding region determined for a blob representing the object; and
apply the first deep learning classification network to the region of interest in the current video frame.

28. The apparatus of claim 21, wherein the processor is configured to:
determining a blob detected in one or more previous video frames is no longer detected in the current frame, the blob being associated with an object in the scene;
determining the object was not classified by the first deep learning classification network in the one or more previous video frames;
identifying a region of interest of a previous video frame containing the object; and
classifying the object contained within the region of interest, wherein the object is classified using a second deep learning classification network applied to the region of interest, the second deep learning classification network having more hidden layers than the first deep learning classification network.

29. The apparatus of claim 21, wherein the apparatus comprises a mobile device.

30. The apparatus of claim 29, further comprising one or more of a camera for capturing the one or more video frames or a display for displaying the one or more video frames.
